(19) United States
(12) Patent Application Publication
(10) Pub. No.: US 2021/0000110 A1
(43) Pub. Date: Jan. 7, 2021

(54) AGRICULTURAL PESTICIDE COMPOSITIONS

(71) Applicant: RHODIA OPERATIONS, Paris (FR)

(72) Inventors: Laurianne, Françoise, Marie MOITY, Lyon (FR); Monique, Martine, Françoise ADAMY, Asnières-sur-Seine (FR)

(21) Appl. No.: 16/761,431

(22) PCT Filed: Nov. 9, 2018
(86) PCT No.: PCT/EP2018/080808

§ 371 Date: May 4, 2020

Related U.S. Application Data
(60) Provisional application No. 62/583,821, filed on Nov. 9, 2017.

(51) Int. Cl. A01N 37/40; A01N 25/04; A01N 33/08; A01N 25/08

(52) U.S. Cl. CPC A01N 37/40; A01N 25/08; A01N 33/08; A01N 25/04

(57) ABSTRACT

The present invention relates to an aqueous composition comprising at least an auxin herbicide and a drift control agent. It relates more particularly to a concentrated blend of at least one water-soluble salt of an auxin herbicide and of a drift control agent.

This application claims priority to U.S. provisional application No. 62/583,821 filed on Nov. 9, 2017, the whole content of this application being incorporated herein by reference for all purposes.

The present invention relates to an aqueous composition comprising at least an auxin herbicide and a drift control agent.

It relates more particularly to a concentrated blend of at least one water-soluble salt of an auxin herbicide and of a drift control agent.

Auxin herbicides are a well-known class of herbicides used to kill weeds by inducing hormonal effects on sprayed plants. They are thus commonly used to control auxin-susceptible plant growth. Typical representatives of auxin herbicides include 2,4-D (2,4-dichlorophenoxyacetic acid) and dicamba (3,6-dichloro-2-methoxybenzoic acid).

Spray drift is a problem frequently faced when using this class of herbicides.

Spray drift is defined by the Environmental Protection Agency as the movement of pesticide dust or droplets through the air at the time of application or soon thereafter, to any site other than the area intended.

Non-target plant damage associated with auxin herbicide spray drift is a major concern for crop growers nowadays. As a matter of fact, unintentional application of auxin herbicides to a sensitive plant generally causes severe injury, loss of yield, and even death of the non-target plants.

This is the reason why there is an increasing demand today for auxin herbicide compositions with improved spray drift control properties.

Various drift control agents are already known in the art. Drift control agents can be defined as chemical agents that enhance drift control of spray applied pesticide composition and/or provides “anti-rebound” properties to the spray applied pesticide composition, that is, reduces rebound of the spray applied pesticide from a target substrate, such as e.g., the foliage of a target plant.

Typical examples of drift control agents include for instance polysaccharide polymers, polyacrylamide polymers and emulsified fatty compounds.

As a rule, the drift control agent may be added to the spray tank (so-called tank-mix adjuvants) or may be incorporated directly into the concentrated herbicide composition (so-called built-in adjuvants).

Tank mixes are combinations of agricultural products (pesticide formulation and tank mix adjuvant compositions) that a farmer would pour into a tank (in which the tank mix is prepared), with water and perhaps other additives, mix (optionally by stirring) and then apply on the field shortly thereafter, as these mixes are typically not stable for extended periods of time. However, tank mixes face a variety of issues such as use of incorrect ingredients, human error in measuring the relative component amounts, and improper mixing steps. This can result in reduced effectiveness of the spray formulation, precipitation or gelation in the tank, clogged spray nozzles or clogged screens, excessive residue or runoff, or plant phytotoxicity.

The use of known drift control agents for preparing a tank mix composition of an auxin herbicide has already been reported in the past.

Given the drawbacks associated with tank mixes, there remains a need today for stable concentrated compositions of one water-soluble salt of an auxin herbicide that contain a sufficient amount of a drift control agent in a one-pack concept (built-in), that is to say for composition of one water-soluble salt of an auxin herbicide that comprises a relatively high concentration of an auxin herbicide, in particular a high concentration of a water-soluble salt of an auxin herbicide, and of a drift control agent, and that is intended to be heavily diluted at the point of use to provide an auxin herbicide composition for application to target pests exhibiting an improved drift control.

In particular, there remains a need today for stable concentrated compositions of at least one water-soluble salt of an auxin herbicide that contain a relatively high amount of a water-soluble salt (whether it be a water-soluble salt of said auxin herbicide alone or a combination of a water-soluble salt of said auxin herbicide with a water-soluble salt of an additional herbicide and/or with added water-soluble salt) and a sufficient amount of a drift control agent and that does not require the use of a separate tank-mix adjuvant by the end user to realize the full biological potential of the dose of herbicide applied per unit crop area and/or to achieve acceptable drift control.

There remains more particularly a need today for stable concentrated compositions of at least one water-soluble salt of an auxin herbicide that exhibit at the same time acceptable storage stability, dilution miscibility and stability and acceptable spray drift control properties when said concentrated composition is diluted in water in a spray tank for soil or foliar application.

One of the major challenges to resolve the above-mentioned technical problems is to incorporate significant amounts of known drift control agents, such as for instance polysaccharide polymers, polyacrylamide polymers and emulsified fatty compounds, into concentrated compositions of at least one water-soluble salt of an auxin herbicide containing a relatively high amount of a water-soluble salt (whether it be a water-soluble salt of said auxin herbicide alone or a combination of a water-soluble salt of said auxin herbicide with a water-soluble salt of an additional herbicide and/or with added water-soluble salt), while improving at least one of the target attributes of said concentrated composition, in particular storage stability, dilution miscibility and stability and acceptable spray drift control properties when said concentrated composition is diluted in water in a spray tank for soil or foliar application.

Incorporating significant amounts of drift control agents is critical in concentrated compositions since, as mentioned previously, said concentrated compositions are then intended to be heavily diluted at the point of use and the diluted composition shall include a minimum amount of said drift control agent to achieve acceptable drift control.

It is widely known that typical polymeric drift control agents, in particular water-soluble polymers such as polysaccharide polymers (e.g. guars) or polyacrylamide polymers, need to be added into such formulations in a suspended form (for instance in a incompletely hydrated form) to avoid a significant and detrimental increase in viscosity. As a matter of fact, even a low amount of water-soluble polymer, when in a hydrated state, can yield to a formulation that is no longer pourable, for example, as a gel.

When the drift control agent is in the form of an emulsified fatty compound, it is common to use a suspending agent to favor long term stability of the emulsion in order to avoid phase separation which would be also detrimental to the formulation stability and/or to the drift control properties.

The main difficulty lies in the fact that the performances of traditional suspending agents, such as for instance xanthan gum, or silica used in the prior art, are reduced in the presence of a relatively high amount of a water-soluble salt, which may especially impact some target attributes, such as for instance storage stability over time. As a matter of fact, the presence of a relatively high amount of a water-soluble salt (and thus a high electrolytic level) in the concentrated composition can potentially prevent the full hydration of such traditional suspending agents, thereby negatively impacting their performances.

This may result, for instance, in deteriorated suspending properties or in a negative impact on long term stability or in the presence of residual gel particles, or even in the hydration of water-soluble drift control polymers, leading to progressive viscosity increase of the composition or to rapid phase separation.

There remains thus a need for a suspending agent exhibiting improved properties, especially in the presence of a relatively high amount of a water-soluble salt, and making it possible to prepare stable concentrated compositions of at least one water-soluble salt of an auxin herbicide and of at least one drift control agent, in particular in the case where said drift control agent is in the form of particles (for instance particles of an incompletely hydrated water-soluble polymer) or in the form of droplets (for instance droplets of a fatty drift control agent formulated as an emulsion).

It is in particular desirable to provide a stable concentrated composition of at least one water-soluble salt of an auxin herbicide and of at least one drift control agent as described previously that exhibit improved properties especially in terms of storage stability, dilution miscibility and stability and/or acceptable spray drift control properties when said concentrated composition is diluted in water in a spray tank for soil or foliar application.

It has now been discovered, unexpectedly, that the use of a specific suspending agent or a combination of specific suspending agents made it possible to achieve this goal.

In particular, it has been discovered that the specific suspending agent of the invention as described below was particularly effective to bring improved suspension properties under such conditions (namely in concentrated formulations containing a relatively high amount of a water-soluble salt and a drift control agent as described previously).

The present invention relates to, in one aspect, a pesticide composition comprising, by total weight of the composition:
a pesticide comprising at least one water-soluble salt of an auxin herbicide;
greater than about 0.5 wt % of a drift control agent suspended in an aqueous liquid medium; and
a suspending agent in an amount effective to impart shear thinning properties to the composition, the suspending agent comprising at least one hydrophobic silica.

Advantageously, the suspending agent is present in an amount effective to impart shear thinning properties to the composition.

The drift control agent of the invention (which is either in the form of particles (for instance particles of an incompletely hydrated water-soluble polymer) or in the form of droplets (for instance droplets of a fatty drift control agent formulated as an emulsion)) will thus remain suspended if the yield strength in the medium is sufficient to overcome the effect of settling or buoyancy on those particles/droplets.

Should the disclosure of any patents, patent applications, and publications which are incorporated herein by reference conflict with the description of the present application to the extent that it may render a term unclear, the present description shall take precedence.

### Auxin Herbicide

The term “auxin herbicide” refers to a herbicide that functions as a mimic of an auxin plant growth hormone, thereby affecting plant growth regulation. Examples of auxin herbicides that are suitable for use in the herbicidal compositions of the present invention include, without limitation, benzoic acid herbicides, phenoxy herbicides, pyridine carboxylic acid herbicides, pyridine oxy herbicides, pyrimidine carboxy herbicides, quinoline carboxylic acid herbicides, and benzothiazole herbicides.

According to anyone of the invention embodiments, the auxin herbicide is selected in the group consisting of 2,4-D (2,4-dichlorophenoxyacetic acid), 2,4-DB (4-(2,4-dichlorophenoxy)butanoic acid), dichloroprop (2-(2,4-dichlorophenoxy)propanoic acid), MCPA ((4-chloro-2-methylphenoxy)acetic acid), MCPB (4-(4-chloro-2-methylphenoxy)butanoic acid), aminopyralid (4-amino-3,6-dichloro-2-pyridinecarboxylic acid), clopyralid (3,6-dichloro-2-pyridinecarboxylic acid), fluoroxypyr ([(4-amino-3,5-dichloro-6-fluoro-2-pyridinyl)oxy]acetic acid), triclopyr ([(3,5,6-trichloro-2-pyridinyl)oxy]acetic acid), diclopyr, mecoprop (2-(4-chloro-2-methylphenoxy)propanoic acid) and mecoprop-P, dicamba (3,6-dichloro-2-methoxybenzoic acid), picloram (4-amino-3,5,6-trichloro-2-pyridinecarboxylic acid), quinclorac (3,7-dichloro-8-quinolinecarboxylic acid), aminocyclopyrachlor (6-amino-5-chloro-2-cyclopropyl-4-pyrimidinecarboxylic acid), agriculturally acceptable salts of any of these herbicides, racemic mixtures and resolved isomers thereof, and mixtures thereof.

According to anyone of the invention embodiments, the auxin herbicide is dicamba, or an agriculturally acceptable salt or ester thereof, for instance dicamba sodium salt, dicamba potassium salt, dicamba monoethanolamine salt, dicamba diethanolamine salt, dicamba isopropylamine salt, dicamba diglycolamine salt, dicamba N,N-bis-(3-aminopropyl)methylamine salt or dicamba dimethylamine salt. In one embodiment, the dicamba salt is (i) a secondary, tertiary or quaternary alkylamine or (ii) a primary, secondary, tertiary or quaternary alkanolamine, alkylalkanolamine or alkoxyalkanolamine salt, wherein the alkyl and alkanol groups are saturated and contain from C1-C4 carbon atoms.

According to anyone of the invention embodiments, the pesticide comprises a dicamba salt, wherein the salt is N,N-bis(3-aminopropyl)methylamine, diethanolamine, monoethanolamine, dimethylamine, isopropylamine, dimethylethanolamine, diglycolamine, potassium, choline, or sodium.

According to anyone of the invention embodiments, the pesticide comprises dicamba diglycolamine (DGA) salt or dicamba N,N-bis(3-aminopropyl)methylamine (BAPMA) salt.

Other dicamba salts that can be used according to the present invention, especially dicamba polyamine salts, are recited for instance in WO2013/189773 which is herein incorporated by reference in its entirety.

According to another one of the invention embodiments, the herbicidal composition comprises at least 2,4-D, or an agriculturally acceptable salt or ester thereof.

For instance, a herbicidal composition of the invention may comprise a 2,4-D salt selected in the group consisting of: the choline, dimethylamine, and isopropylamine salts, and combinations thereof.

For instance, a herbicidal composition of the invention may comprise a 2,4-D ester selected in the group consisting of: the methyl, ethyl, propyl, butyl (2,4-DB), and isooctyl esters, and combinations thereof.

According to anyone of the invention embodiments, the concentrated composition of the invention contains at least one water-soluble salt of an auxin herbicide as described previously, in particular at least one agriculturally acceptable water-soluble salt of dicamba, for instance dicamba sodium salt, dicamba potassium salt, dicamba monoethanolamine salt, dicamba diethanolamine salt, dicamba isopropylamine salt, dicamba diglycolamine salt, dicamba N,N-bis-(3-aminopropyl)methylamine salt or dicamba dimethylamine salt, and combinations thereof.

According to anyone of the invention embodiments, the concentrated composition of the invention contains at least one water-soluble salt of an auxin herbicide as described previously, in particular at least one agriculturally acceptable water-soluble salt of 2,4-D, for instance 2,4-D choline salt, 2,4-D dimethylamine salt, or 2,4-D isopropylamine salt, and combinations thereof.

A concentrated composition of the invention usually contains at least 300 g/l, more preferably at least 400 g/l, and in particular at least 450 g/l acid equivalents (a.e.) of auxin herbicide, in particular dicamba.

According to anyone of the invention embodiments, the concentrated composition of the invention may comprise at least 300 g/L acid equivalents (a.e.) of at least one water-soluble salt of an auxin herbicide, in particular dicamba.

A concentrated composition of the invention contains usually up to 800 g/l, preferably up to 700 g/l, more preferably up to 650 g/l, and in particular up to 600 g/l acid equivalents (a.e.) of auxin herbicide, in particular dicamba.

### Aqueous Liquid Medium

A composition of the invention comprises an aqueous liquid medium.

As used herein, the terminology “aqueous medium” means a single phase liquid medium that contains more than a trace amount of water, typically, based on 100 pbw of the aqueous medium, more than 0.1 pbw water. Suitable aqueous media more typically comprise, based on 100 pbw of the aqueous medium, greater than about 5 pbw water, even more typically greater than 10 pbw water. In one embodiment, the aqueous medium comprises, based on 100 pbw of the aqueous medium, greater than 40 pbw water, more typically, greater than 50 pbw water. The aqueous medium may, optionally, further comprise water soluble or water miscible components dissolved in the aqueous medium. The terminology “water miscible” as used herein means miscible in all proportions with water. Suitable water miscible organic liquids include, for example, (C₁-C₃)alcohols, such as methanol, ethanol, and propanol, and (C₁-C₃)polyols, such as glycerol, ethylene glycol, and propylene glycol.

According to anyone of the invention embodiments, a composition of the invention comprises greater than about 5 wt % of an aqueous liquid medium, for instance greater than about 10 wt %, for instance from about 10 wt % to about 80 wt %, for instance from about 15 wt % to about 75 wt % of an aqueous liquid medium relative to the total weight of the composition.

### Suspending Agent

The suspending agent used in a composition of the present invention comprises at least one hydrophobic silica.

Hydrophobic silica used in the present invention comprises hydrophobic fumed silica and hydrophobic precipitation-process silica (also known as “precipitated” silica), among which the hydrophobic fumed silica is preferred.

After having been substituted by alkyl groups, the silica products are classified according to the different substitution groups into silylated silica, dimethyl-silylated silica, trimethyl-silylated silica and polydimethylsiloxane-silylated silica.

The hydrophobic silica can have been hydrophobized by means of a surface-modifying agent or by means of a silane.

A compound from the following list can be used as surface-modifying agent or as silane:

a) organosilanes of the type (RO)₃Si(CₙH₂ₙ₊₁) and (RO)₃Si(CₙH₂ₙ₋₁)
R=alkyl, e.g. methyl, ethyl, n-propyl, iso-propyl, butyl
n=from 1 to 20
b) organosilanes of the type R′ₓ(RO)_{y}Si(CₙH₂ₙ₊₁) and R′ₓ(RO)_{y}Si(CₙH₂ₙ₋₁)
R=alkyl, e.g. methyl, ethyl, n-propyl, iso-propyl, butyl
R′=alkyl, e.g. methyl, ethyl, n-propyl, iso-propyl, butyl or cycloalkyl
n=from 1 to 20
x+y=3
x=1 or 2
y=1 or 2
c) haloorganosilanes of the type X₃Si(CₙH₂ₙ₊₁) and X₃Si(CₙH₂ₙ₋₁)

### X=Cl, Br

n=from 1 to 20
d) haloorganosilanes of the type X₂(R′)Si(CₙH₂ₙ₊₁) and X₂(R′)Si(CₙH₂ₙ₊₁)

### X=Cl, Br

R′=alkyl, e.g. methyl, ethyl, n-propyl, iso-propyl, butyl or cycloalkyl
n=from 1 to 20
e) haloorganosilanes of the type X(R′)₂Si(CₙH₂ₙ₊₁) and X(R′)₂Si(CₙH₂ₙ₋₁)

### X=Cl, Br

R′=alkyl, e.g. methyl, ethyl, n-propyl, iso-propyl, butyl or cycloalkyl
n=from 1 to 20
f) organosilanes of the type (RO)₃Si(CH₂)ₘ—R′
R=alkyl, e.g. methyl, ethyl, propyl
m=0, or from 1 to 20
R′=methyl, aryl (e.g. —C₆H₅, substituted phenyl radicals)
—C₄F₉, OCF₂—CHF—CF₃, —C₆F₁₃, —O—CF₂—CHF₂
—NH₂, —N₃, —SCN, —CH═CH₂, —NH—CH₂—CH₂—NH₂,
—N—(CH₂—CH₂—NH₂)₂
—OOC(CH₃)C═CH₂
—OCH₂—CH(O)CH₂
—NH—CO—N—CO—(CH₂)₅
—NH—COO—CH₃, —NH—COO—CH₂—CH₃, —NH—(CH₂)₃Si(OR)₃, where R can be methyl, ethyl, propyl, butyl
—Sₓ—(CH₂)₃Si(OR)₃, where R can be methyl, ethyl, propyl, butyl,

### —SH

—NR′R″R′″ (R′=alkyl, aryl; R″=H, alkyl, aryl; R′″=H, alkyl, aryl, benzyl, C₂H₄NR″″R′″″, where
R″″=H, alkyl and R′″″=H, alkyl)
g) organosilanes of the type (R″)ₓ(RO)_{y}Si(CH₂)ₘ—R′
R″=alkyl or cycloalkyl
x+y=2
x=1 or 2
y=1 or 2
m=0 or from 1 to 20
R′=methyl, aryl (e.g. —C₆H₅, substituted phenyl radicals)
—C₄F₉, OCF₂—CHF—CF₃, —C₆F₁₃, —O—CF₂—CHF₂
—NH₂, —N₃, —SCN, —CH═CH₂, —NH—CH₂—CH₂—NH₂,
—N—(CH₂—CH₂—NH₂)₂
—OOC(CH₃)C═CH₂
—OCH₂—CH(O)CH₂
—NH—CO—N—CO—(CH₂)₅
—NH—COO—CH₃, —NH—COO—CH₂—CH₃, —NH—(CH₂)₃Si(OR)₃, where R can be methyl, ethyl, propyl, butyl
—Sₓ—(CH₂)₃Si(OR)₃, where R can be methyl, ethyl, propyl, butyl,

### —SH

—NR′R″R′″ (R′=alkyl, aryl; R″=H, alkyl, aryl; R′″=H, alkyl, aryl, benzyl, C₂H₄NR″″R′″″, where
R″″=H, alkyl and R′″″=H, alkyl)
h) haloorganosilanes of the type X₃Si(CH₂)ₘ—R′

### X=Cl, Br

m=0 or from 1 to 20
R′=methyl, aryl (e.g. —C₆H₅, substituted phenyl radicals)
—C₄F₉, OCF₂—CHF—CF₃, —C₆F₁₃, —O—CF₂—CHF₂—NH₂, —N₃, —SCN, —CH═CH₂, —NH—CH₂—CH₂—NH₂,
—N—(CH₂—CH₂—NH₂)₂
—OOC(CH₃)C═CH₂
—OCH₂—CH(O)CH₂
—NH—CO—N—CO—(CH₂)₅
—NH—COO—CH₃, —NH—COO—CH₂—CH₃, —NH—(CH₂)₃Si(OR)₃, where R can be methyl, ethyl, propyl, butyl
—Sₓ—(CH₂)₃Si(OR)₃, where R can be methyl, ethyl, propyl, butyl,

### —SH

i) haloorganosilanes of the type (R)X₂Si(CH₂)ₘ—R′

### X=C, Br

R=alkyl, e.g. methyl, ethyl, propyl
m=0 or from 1 to 20
R′=methyl, aryl (e.g. —C₆H₅, substituted phenyl radicals)
—C₄F₉, OCF₂—CHF—CF₃, —C₆F₁₃, —O—CF₂—CHF₂
—NH₂, —N₃, —SCN, —CH═CH₂, —NH—CH₂—CH₂—NH₂,
—N—(CH₂—CH₂—NH₂)₂
—OOC(CH₃)C═CH₂
—OCH₂—CH(O)CH₂
—NH—CO—N—CO—(CH₂)₅
—NH—COO—CH₃, —NH—COO—CH₂—CH₃, —NH—(CH₂)₃Si(OR)₃, where R can be methyl, ethyl, propyl, butyl
—Sₓ—(CH₂)₃Si(OR)₃, where R can be methyl, ethyl, propyl, butyl,

### —SH

j) haloorganosilanes of the type (R)₂XSi(CH₂)ₘ—R′

### X=Cl, Br

R=alkyl
m=0 or from 1 to 20
R′=methyl, aryl (e.g. —C₆H₅, substituted phenyl radicals)
—C₄F₉, OCF₂—CHF—CF₃, —C₆F₁₃, —O—CF₂—CHF₂
—NH₂, —N₃, —SCN, —CH═CH₂, —NH—CH₂—CH₂—NH₂,
—N—(CH₂—CH₂—NH₂)₂
—OOC(CH₃)C═CH₂
—OCH₂—CH(O)CH₂
—NH—CO—N—CO—(CH₂)₅
—NH—COO—CH₃, —NH—COO—CH₂—CH₃, —NH—(CH₂)₃Si(OR)₃, where R can be methyl, ethyl, propyl, butyl
—Sₓ—(CH₂)₃Si(OR)₃, where R can be methyl, ethyl, propyl, butyl,

### —SH

k) silazanes of the type

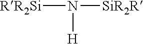

R=alkyl, vinyl, aryl
R′=alkyl, vinyl, aryl
l) cyclic polysiloxanes of the type D 3, D 4, D 5, where D 3, D 4 and D 5 are cyclic polysiloxanes having 3, 4 or 5 units of the type —O—Si (CH₃)₂—.

For example, octamethylcyclotetrasiloxane=D 4

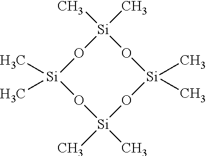

m) polysiloxanes or silicone oils of the type

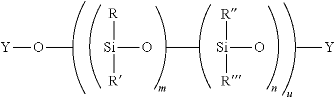

m=0, 1, 2, 3, . . . ∞
n=0, 1, 2, 3, . . . ∞
u=0, 1, 2, 3, . . . ∞
Y=CH₃, H, CₙH₂ₙ₊₁ n=1-20
Y=Si(CH₃)₃, Si(CH₃)₂H Si(CH₃)₂OH, Si(CH₃)₂(OCH₃) Si(CH₃)₂(CₙH₂ₙ₊₁) n=1-20
R=alkyl, e.g. CₙH₂ₙ₊₁, where n=from 1 to 20, aryl, e.g. phenyl and substituted phenyl radicals, (CH₂)ₙ—NH₂, H
R′=alkyl, e.g. CₙH₂ₙ₊₁, where n=from 1 to 20, aryl, e.g. phenyl and substituted phenyl radicals, (CH₂)ₙ—NH₂, H
R″=alkyl, e.g. CₙH₂ₙ₊₁, where n=from 1 to 20, aryl, e.g. phenyl and substituted phenyl radicals, (CH₂)ₙ—NH₂, H
R′″=alkyl, e.g. CₙH₂ₙ₊₁, where n=from 1 to 20, aryl, e.g. phenyl and substituted phenyl radicals, (CH₂)ₙ—NH₂, H.

According to anyone of the invention embodiments, the hydrophobic silica of the invention is a hydrophobic fumed silica which has been hydrophobized by mean of an haloorganosilane of the type X₂(R′)Si(CₙH₂ₙ₊₁) and X₂(R′)Si(CₙH₂ₙ₊₁), wherein X=Cl or Br; R′=alkyl (e.g. methyl, ethyl, n-propyl, iso-propyl, butyl or cycloalkyl, preferably methyl) and n=from 1 to 20, preferably from 1 to 3.

According to anyone of the invention embodiments, the hydrophobic silica of the invention has a BET surface area of 70-350 m²/g, and preferably 80-300 m²/g.

Particularly suited for the present invention are hydrophobic fumed silicas having a BET surface area comprised between 100 and 250 m²/g, for instance between 150 and 200 m²/g. According to anyone of the invention embodiments, the hydrophobic silica of the invention has a pH (measured in accordance to DIN EN ISO 787/9, ASTM D 1208, JIS K 5101/24 in water:methanol=1:1) comprised between 3.5 and 7.5, preferably between 3.5 and 6.5.

Particularly suited for the present invention are hydrophobic fumed silicas having a pH (measured in accordance to DIN EN ISO 787/9, ASTM D 1208, JIS K 5101/24 in water:methanol=1:1) comprised between 3.5 and 5.0.

As mentioned previously, hydrophobic (i.e. water-repellent) silicas are typically created by subjecting hydrophilic (i.e. able to be wetted by water) silicas to chemical post-treatment by means of a surface-modifying agent or by means of a silane.

In the end product, parts of the post-treatment agent have formed a firm chemical bond with the previously hydrophilic oxide.

Hydrophobizing substantially reduces the amount of moisture that is absorbed by hydrophilic silicas. This is the reason why hydrophobic silicas generally display a lower moisture uptake, compared to hydrophilic silicas.

For example, Aerosil R974, even at a relative air humidity of 80%, adsorbs just 0.5% water, whereas the hydrophilic Aerosil 200 with a comparable surface area absorbs some 10 times more.

According to anyone of the invention embodiments, the hydrophobic silica of the invention has a loss on drying (2 h at 105° C., when leaving the plant, measured in accordance to DIN EN ISO 787/2, ASTM D 280, JIS K 5101/21) lower than or equal to 2.0, especially lower than or equal to 1.0 and preferably lower than or equal to 0.5.

In one embodiment, the hydrophobic silica may be a hydrophobic precipitated silica.

The hydrophobic precipitated silica suitable for the present invention includes SIPERNAT® D17 precipitation silica (supplied by Evonik Degussa GmbH).

In another embodiment, the hydrophobic silica may be a hydrophobic fumed silica.

The hydrophobic fumed silica includes the hydrophobic fumed silica supplied under the trade name of AEROSIL®, Cab-o-Sil and MK®, and is preferably one or more selected from the group consisting of AEROSIL® R202, AEROSIL® R972, AEROSIL® R805, AEROSIL® R8200, AEROSIL® R974, AEROSIL® R812S and AEROSIL® R812 (all supplied by Evonik Degussa GmbH).

According to anyone of the invention embodiments, the hydrophobic silica of the invention is an hydrophobic fumed silica which has been hydrophobized by means of dimethyldichlorosilane.

Fumed silica hydrophobized by means of dimethyldichlorosilane is known for instance from DE 11 63 784. Typical examples of fumed silica hydrophobized by means of dimethyldichlorosilane include the fumed silica AEROSIL R974, which can preferably be used.

According to anyone of the invention embodiments, a concentrated composition of the invention comprises greater than about 0.5 wt % of hydrophobic silica, for instance greater than about 1 wt % of hydrophobic silica, relative to the total weight of the concentrated composition.

According to anyone of the invention embodiments, a concentrated composition of the invention comprises less than about 25 wt % of hydrophobic silica, for instance less than about 15 wt % of hydrophobic silica, for instance less than about 10 wt % of hydrophobic silica, relative to the total weight of the concentrated composition.

The present invention provides a pesticide composition characterized in that it comprises, as suspending agent, an hydrophobic silica, preferably a hydrophobic fumed silica, in particular a fumed silica which has been hydrophobized by dimethyldichlorosilane.

Another preferred subject matter of the invention is a process for the preparation of a concentrated composition of at least one water-soluble salt of an auxin herbicide exhibiting at the same time acceptable storage stability, dilution miscibility and stability and acceptable spray drift control properties when said concentrated composition is diluted in water in a spray tank, which is characterized in that a hydrophobic silica, preferably a hydrophobic fumed silica, in particular a fumed silica which has been hydrophobized by dimethyldichlorosilane, is added to the concentrated composition.

Another preferred subject matter of the invention is the use of a hydrophobic silica, preferably a hydrophobic fumed silica, in particular a fumed silica which has been hydrophobized by dimethyldichlorosilane, for the improvement of the storage stability and of the suspending properties of a concentrated composition of the invention.

In one embodiment, the suspension agent provides improved storage stability and suspending properties of a concentrated composition of the invention. In another embodiment, the suspension agent provides improved high temperature storage stability.

In one embodiment, the suspending agent of the present invention in utilized in an amount that is effective, either alone or in combination with one or more other suspending agents, to impart shear thinning viscosity to the composition, typically in an amount, based on 100 pbw of the composition, of at least 0.5 pbw, for instance of from greater than 1 pbw, more typically from about 2 pbw, and even more typically from about 1 pbw, to about 10 pbw, more typically to about 8 pbw, and even more typically to about 5 pbw.

### Drift Control Agent

As used herein, the term “drift” refers to off-target movement of droplets of a pesticide composition that is applied to a target pest or environment for the pest. Spray applied compositions typically exhibit decreasing tendency to drift with decreasing relative amount, typically expressed as a volume percentage of total spray applied droplet volume, of small size spray droplets, that is, spray droplets having a droplet size below a given value, typically, a droplet size of less than 150 micrometers (“μm”). Spray drift of pesticides can have undesirable consequences, such as for example, unintended contact of phytotoxic pesticides with non-pest plants, such as crops or ornamental plants, with damage to such non-pest plants.

In one embodiment, spray drift can me measured as follows: the aqueous pesticide compositions as described herein are sprayed through a nozzle under certain conditions, for example, a single, stationary XR11002 flat fan nozzle (Teejet) with an output of 0.64 liter in⁻¹ at a pressure of 30 psi (˜2 bar) in a flow-controlled hood (speed ˜1.6 MPH), and a droplet size distribution was measured perpendicular to the plane of spray pattern and below the nozzle tip, e.g., 35 cm. An analyzer such as a HELOS VARIO particle size analyzer (Sympatec) can be used to measure the spray droplets using a R7 lens. The volume mean diameter (“VMD”) of the spray droplets, expressed in micrometers (“μm”), and relative amount, expressed as percent by volume of the total spray volume (“vol %”), of droplets below 150 μm can be ascertained. It is desirable for spray compositions to exhibit a smaller amount of small size spray droplets that are very susceptible to spray drift, i.e., droplets below 150 μm in size, compared to respective analogous compositions or compositions without a drift control agent.

A composition of the invention may comprise any compound useful as drift control agent. Water soluble polymers and fatty deposition control agents as described below are typical examples of suitable drift control agents according to the present invention.

### Water Soluble Polymer as a Drift Control Agent

Suitable drift control agents include water soluble polysaccharide polymers, for example, galactomannans such as guars, including guar derivatives, xanthans, polyfructoses such as levan, starches, including starch derivatives, such as amylopectin, and cellulose, including cellulose derivatives, such as methylcellulose, ethylcellulose, carboxymethylcellulose, hydroxyethylcellulose, cellulose acetate, cellulose acetate butyrate, and cellulose acetate propionate.

Galactomannans are polysaccharides consisting mainly of the monosaccharides mannose and galactose. The mannose-elements form a chain consisting of many hundreds of (1,4)-ß-D-mannopyranosyl-residues, with 1,6 linked ß-D-galactopyranosyl-residues at varying distances, dependent on the plant of origin. Naturally occurring galactomannans are available from numerous sources, including guar gum, guar splits, locust bean gum and tara gum. Additionally, galactomannans may also be obtained by classical synthetic routes or may be obtained by chemical modification of naturally occurring galactomannans.

Guar gum refers to the mucilage found in the seed of the leguminous plant Cyamopsis tetragonolobus. The water soluble fraction (85%) is called “guaran,” which consists of linear chains of (1,4)-β-D mannopyranosyl units-with α-D-galactopyranosyl units attached by (1,6) linkages. The ratio of D-galactose to D-mannose in guaran is about 1:2. Guar gum typically has a weight average molecular weight of between 2,000,000 and 5,000,000 g/mol. Guars having a reduced molecular weight, such as for example, from about 50,000 to about 2,000,000 g/mol are also known.

Guar seeds are composed of a pair of tough, non-brittle endosperm sections, hereafter referred to as “guar splits,” between which is sandwiched the brittle embryo (germ). After dehulling, the seeds are split, the germ (43-47% of the seed) is removed by screening, and the splits are ground. The ground splits are reported to contain about 78-82% galactomannan polysaccharide and minor amounts of some proteinaceous material, inorganic salts, water-insoluble gum, and cell membranes, as well as some residual seedcoat and embryo.

Locust bean gum or carob bean gum is the refined endosperm of the seed of the carob tree, Ceratonia siliqua. The ratio of galactose to mannose for this type of gum is about 1:4.

Locust bean gum is commercially available.

Tara gum is derived from the refined seed gum of the tara tree. The ratio of galactose to mannose is about 1:3. Tara gum is commercially available.

In one embodiment, native (i.e. not derivatized) polysaccharide gums, such as for instance native guar gum, cassia gum or tamarind seed gum, are suitable drift control agents according to the present invention.

Other galactomannans of interest are the modified galactomannans, including derivatized guar polymers, such as carboxymethyl guar, carboxymethylhydroxypropyl guar, cationic hydroxpropyl guar, hydroxyalkyl guar, including hydroxyethyl guar, hydroxypropyl guar, hydroxybutyl guar and higher hydroxylalkyl guars, carboxylalkyl guars, including carboxymethyl guar, carboxylpropyl guar, carboxybutyl guar, and higher carboxyalkyl guars, the hydroxyethylated, hydroxypropylated and carboxymethylated derivative of guaran, the hydroxethylated and carboxymethylated derivatives of carubin, and the hydroxypropylated and carboxymethylated derivatives of cassia-gum.

Xanthans of interest are xanthan gum and xanthan gel. Xanthan gum is a polysaccharide gum produced by Xathomonas campestris and contains D-glucose, D-mannose, D-glucuronic acid as the main hexose units, also contains pyruvate acid, and is partially acetylated.

Levan is a polyfructose comprising 5-membered rings linked through β-2,6 bonds, with branching through β-2,1 bonds. Levan exhibits a glass transition temperature of 138° C. and is available in particulate form. At a molecular weight of 1-2 million, the diameter of the densely-packed spherulitic particles is about 85 nm.

Modified celluloses are celluloses containing at least one functional group, such as a hydroxy group, hydroxycarboxyl group, or hydroxyalkyl group, such as for example, hydroxymethyl cellulose, hydroxyethyl celluloses, hydroxypropyl celluloses or hydroxybutyl celluloses.

Processes for making derivatives of guar gum splits are generally known. Typically, guar splits are reacted with one or more derivatizing agents under appropriate reaction conditions to produce a guar polysaccharide having the desired substituent groups. Suitable derivatizing reagents are commercially available and typically contain a reactive functional group, such as an epoxy group, a chlorohydrin group, or an ethylenically unsaturated group, and at least one other substituent group, such as a cationic, nonionic or anionic substituent group, or a precursor of such a substituent group per molecule, wherein substituent group may be linked to the reactive functional group of the derivatizing agent by bivalent linking group, such as an alkylene or oxyalkylene group. Suitable cationic substituent groups include primary, secondary, or tertiary amino groups or quaternary ammonium, sulfonium, or phosphinium groups. Suitable nonionic substituent groups include hydroxyalkyl groups, such as hydroxypropyl groups. Suitable anionic groups include carboxyalkyl groups, such as carboxymethyl groups. The cationic, nonionic and/or anionic substituent groups may be introduced to the guar polysaccharide chains via a series of reactions or by simultaneous reactions with the respective appropriate derivatizing agents.

The guar may be treated with a crosslinking agent, such for example, borax (sodium tetra borate) is commonly used as a processing aid in the reaction step of the water-splits process to partially crosslink the surface of the guar splits and thereby reduces the amount of water absorbed by the guar splits during processing. Other crosslinkers, such as, for example, glyoxal or titanate compounds, are known.

In one embodiment, the drift control agent of the present invention is a non-derivatized galactomannan polysaccharide, more typically a non-derivatized guar gum.

It is understood that the term “non-derivatized guar gum” is synonymous, and used interchangeably, with the terms “native guar” or “guar gum”.

In one embodiment, the drift control agent is a derivatized galactomannan polysaccharide that is substituted at one or more sites of the polysaccharide with a substituent group that is independently selected for each site from the group consisting of cationic substituent groups, nonionic substituent groups, and anionic substituent groups.

In one embodiment, the drift control agent of the present invention is derivatized galactomannan polysaccharide, more typically a derivatized guar. Suitable derivatized guars include, for example, hydroxypropyl trimethylammonium guar, hydroxypropyl lauryldimethylammonium guar, hydroxypropyl stearyldimethylammonium guar, hydroxypropyl guar, carboxymethyl guar, guar with hydroxypropyl groups and hydroxypropyl trimethylammonium groups, guar with carboxymethyl hydroxypropyl groups and mixtures thereof.

The amount of derivatizing groups in a derivatized polysaccharide polymer may be characterized by the degree of substitution of the derivatized polysaccharide polymer or the molar substitution of the derivatized polysaccharide polymer.

As used herein, the terminology “degree of substitution” in reference to a given type of derivatizing group and a given polysaccharide polymer means the number of the average number of such derivatizing groups attached to each monomeric unit of the polysaccharide polymer. In one embodiment, the derivatized galactomannan polysaccharide exhibits a total degree of substitution (“DS_{T}”) of from about 0.001 to about 3.0, wherein:
DS_{T} is the sum of the DS for cationic substituent groups (“DS_{cationic}”), the DS for nonionic substituent groups (“DS_{nonionic}”) and the DS for anionic substituent groups (“DS_{anionic}”),
DS_{cationic} is from 0 to about 3, more typically from about 0.001 to about 2.0, and even more typically from about 0.001 to about 1.0,
DS_{nonionic} is from 0 to 3.0, more typically from about 0.001 to about 2.5, and even more typically from about 0.001 to about 1.0, and
DS_{anionic} is from 0 to 3.0, more typically from about 0.001 to about 2.0.

As used herein, the term “molar substitution” or “ms” refers to the number of moles of derivatizing groups per moles of monosaccharide units of the guar. The molar substitution can be determined by the Zeisel-GC method. The molar substitution utilized by the present invention is typically in the range of from about 0.001 to about 3.

In one embodiment, the drift control agent is a water soluble non-polysaccharide polymer. Suitable water soluble non-polysaccharide polymers include, for example, lecithin polymers, poly(alkyleneoxide) polymers, such as poly(ethylene oxide) polymers, and water soluble polymers derived from ethylenically unsaturated monomers. Suitable water soluble polymers derived from ethylenically unsaturated monomers include water soluble polymers derived from acrylamide, methacrylamide, 2-hydroxy ethyl acrylate, and/or N-vinyl pyrrolidone, including homopolymers of such monomers, such as poly(acrylamide) polymers and poly(vinyl pyrrolidone) polymers, as well as copolymers of such monomers with one or more comonomers. Suitable water soluble copolymers derived from ethylenically unsaturated monomers include water soluble cationic polymers made by polymerization of at least one cationic monomer, such as a diamino alkyl (meth)acrylate or diamino alkyl (meth)acrylamide, or mixture thereof and one or more nonionic monomers, such as acrylamide or methacrylamide. In one embodiment, the non-polysaccharide polymer exhibits a weight average molecular weight of greater than about 1,000,000 g/mol, more typically greater than about 2,000,000 g/mol to about 20,000,000 g/mol, more typically to about 10,000,000 g/mol.

In one embodiment, the drift control agent comprises, for example, galactomannans such as guars, including guar derivatives, polyfructoses such as levan, starches, including starch derivatives, such as amylopectin, xyloglucans such as tamarind gum and tamarind gum derivatives such as hydroxypropyl tamarind gum, and cellulose, including cellulose derivatives, such as methylcellulose, ethylcellulose, carboxymethylcellulose, hydroxyethylcellulose, cellulose acetate, cellulose acetate butyrate, and cellulose acetate propionate, as well as cassia gum.

Tamarind (Tamahndus Indica) is a leguminous evergreen tall tree produced in the tropics. Tamarind gum (tamarind powder or tamarind kernel powder), a xyloglucan polysaccharide, is obtained by extracting and purifying the seed powders, obtained by grinding the seeds of tamarind. The polysaccharide molecule of the tamarind gum consists of a main linear chain of poly-glucose bearing xylose and galactoxylose substituents.

In another embodiment, the drift control agent of the present invention is derivatized xyloglucan polysaccharide, more typically a derivatized tamarind.

Suitable derivatized tamarinds include, for instance, hydroxypropyl tamarind gum, which may further contain substituent groups such as carboxyalkyl substituents (e.g. carboxymethyl or carboxyethyl) or hydrophobic substituents (e.g. C4-C24 linear or branched alkyl chains), such as those described in WO2016/124467, which is incorporated by reference.

According to another one of the invention embodiments, the drift control agent is a cationic tamarind gum derivative, for instance a cationic tamarind gum derivative having a cationic degree of substitution DScat ranging from about 0.001 to about 3.

According to one embodiment, in particular when the drift control agent is a tamarind gum derivative, such as a tamarind seed gum polymer, for instance a hydroxypropyl tamarind, the pesticide composition of the invention does not comprise a combination of dipotassium phosphate and tri-potassium citrate.

According to another embodiment, in particular when the drift control agent is a tamarind gum derivative, such as a tamarind seed gum polymer, for instance a hydroxypropyl tamarind, the pesticide composition of the invention does not comprise a combination of dipotassium phosphate, potassium nitrate and tri-potassium citrate.

In another embodiment, the drift control agent is present in an amount having a lower limit, based on 100 pbw of aqueous solution or composition, of 0.5 pbw, or of 1 pbw, or in another embodiment of 1.2 pbw, or in another embodiment, 1.4 pbw, or in another embodiment, 1.6 pbw, or in another embodiment, 1.8 pbw, or in yet another further embodiment, 2 pbw, or in another embodiment, 2.4 pbw, or in a further embodiment, 3 pbw, or in another embodiment, 3.5 pbw, or in another embodiment, 3.8 pbw, or in another embodiment, 4 pbw, or in another embodiment, 4.5 pbw, or one embodiment, 5 pbw, or in another embodiment, 7 pbw, or in a further embodiment, 8 pbw, or in another embodiment, 10 pbw, or in yet another embodiment, 12 pbw, or in another embodiment, 16 pbw, or in another embodiment, 20 pbw.

In one particular embodiment, the water-soluble polymer is present in an amount having a lower limit, based on 100 pbw of aqueous solution or composition, of 1.8 pbw. In one particular embodiment, the drift control agent, for instance the water-soluble polymer, is present in an amount having a lower limit, based on 100 pbw of aqueous solution or composition, of 3.8 pbw. In one particular embodiment, the drift control agent, for instance the water-soluble polymer, is present in an amount having a lower limit, based on 100 pbw of aqueous solution or composition, of 4 pbw. In one particular embodiment, the drift control agent, for instance the water-soluble polymer, is present in an amount having a lower limit, based on 100 pbw of aqueous solution or composition, of 2 pbw.

In yet another embodiment, the drift control agent, for instance the water-soluble polymer, is present in an amount having an upper limit, based on 100 pbw of aqueous solution or composition, of 20 pbw, or in another embodiment of 18 pbw, or in another embodiment, 17 pbw, or in another embodiment, 16 pbw, or in another embodiment, 14 pbw, or in yet another further embodiment, 13 pbw, or in another embodiment, 12 pbw, or in a further embodiment, 10 pbw, or in another embodiment, 9 pbw, or in another embodiment, 8 pbw, or in another embodiment, 7 pbw, or in another embodiment, 6 pbw, or one embodiment, 5.5 pbw, or in another embodiment, 5 pbw, or in a further embodiment, 4.5 pbw, or in another embodiment, 3 pbw, or in yet another embodiment, 2.5 pbw, or in another embodiment, 2.2 pbw. In one particular embodiment, the drift control agent, for instance the water-soluble polymer, is present in an amount having an upper limit, based on 100 pbw of aqueous solution or composition, of 12 pbw. In one particular embodiment, the drift control agent, for instance the water-soluble polymer, is present in an amount having an upper limit, based on 100 pbw of aqueous solution or composition, of 8 pbw. In one particular embodiment, the drift control agent, for instance the water-soluble polymer, is present in an amount having an upper limit, based on 100 pbw of aqueous solution or composition, of 20 pbw.

According to anyone of the invention embodiments, a composition of the invention may comprise greater than about 1 wt % of a drift control agent suspended in a liquid medium, for instance greater than about 2 wt %, for instance greater than about 3 wt %, for instance greater than about 4 wt %, for instance at least 5 wt % of a drift control agent, for instance an incompletely hydrated water-soluble polymer, suspended in a liquid medium.

In one embodiment, the pesticide composition of the present invention comprises:
(a) at least one an auxin herbicide or salt thereof
(b) a liquid medium,
(c) an incompletely hydrated water-soluble polymer, more typically wherein at least a portion of a water-soluble polymer is in the form of particles of the water-soluble polymer, at least a portion of which are dispersed, more typically suspended in the liquid medium, and
(d) a suspending agent in an amount effective to impart shear thinning properties to the composition;
(e) optionally, a surfactant; and
(f) optionally, hydration inhibitor, which in one embodiment is a glycol, a glycol derivative, a glycerol, a glycerol derivative, or any combination thereof.

### Fatty Deposition Control Agents as a Drift Control Agent

Fatty deposition control agents are also suitable as drift control agents in a composition of the invention.

In particular, emulsified fatty deposition control agents, in particular combinations of a fatty deposition control agent and of a surfactant, may be used according to the invention.

Any known emulsifying surfactant can be combined to a fatty deposition control agent of the invention to obtain an emulsified fatty deposition control agent useful as drift control agent according to the present invention.

Fatty compounds suitable as the fatty deposition control agent as described herein are typically insoluble in water and form a two phase mixture with water in all proportions.

In one embodiment, the fatty deposition control agent comprises one or more fatty alkanes, fatty acids, fatty amines, fatty amides, fatty glycerides, fatty triglycerides, fatty acid esters, or any mixture thereof. In another embodiment, the fatty deposition control agent comprises one or more fatty alkanes, fatty acids, fatty amides, fatty glycerides, or any mixture thereof. For example, the fatty deposition control agent, in one embodiment, is a mixture of a fatty acid and a fatty triglyceride. In another embodiment, the fatty deposition control agent comprises one or more fatty alkanes. In another embodiment, the fatty deposition control agent comprises one or more fatty acids. In another embodiment, the fatty deposition control agent comprises one or more fatty glycerides. In another embodiment, the fatty deposition control agent comprises one or more fatty triglycerides. In another embodiment, the fatty deposition control agent comprises one or more fatty acid esters. In another embodiment, the fatty deposition control agent comprises one or more fatty amines. In another embodiment, the fatty deposition control agent comprises one or more fatty amides.

Suitable glycerides are mono- di-, and/or tri-esters of glycerol with one or more fatty acids. In one embodiment, the fatty deposition control agent comprises one or more fatty glycerides, which may comprise one or more fatty monoglycerides, fatty diglycerides, fatty triglycerides, or a mixture thereof.

In one embodiment, the fatty glyceride or triglyceride comprises one or more compounds according to structure (IIa)

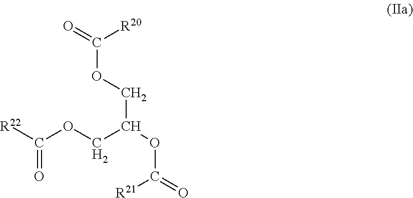

Wherein R²⁰, R²¹, and R²² are each independently H, (C₆-C₃₀)alkyl, (C₁₀-C₂₄)alkyl, or (C₆-C₃₀)alkenyl, more typically (C₁₀-C₂₄)alkenyl. In one embodiment, R²⁰, R²¹, and R²² are each independently (C₁₄-C₁₈)alkyl. In one embodiment, R²⁰, R²¹, and R²² are each independently (C₁₀-C₂₄)alkyl. In one embodiment, R²⁰, R²¹, and R²² are each independently (C₁₆-C₁₃)alkyl. In one embodiment, R²⁰, R²¹, and R²² are each independently (C₆-C₃₀)alkyl. In one embodiment, R²⁰, R²¹, and R²² are each independently (C₆-C₃₀)alkenyl. In one embodiment, R²⁰, R²¹, and R²² are each independently (C₁₀-C₂₄)alkenyl. R²⁰, R²¹, and R²² may each be linear or branched and may each, optionally, be substituted on one or more carbon atoms with hydroxyl, and provided that at least one of R²⁰, R²¹, and R²² is not H.

Alkyl moieties suitable as groups of structure (IIa) include, for example, (C₄-C₃₀)hydrocarbon group.

Alkenyl moieties suitable as groups of structure (IIa) may be mono-unsaturated or poly-unsaturated.

In one embodiment, the fatty glyceride comprises one or more fatty monoglyceride compounds according to structure (IIa) wherein two of R²⁰, R²¹ and R²² are each independently H and the remaining one of R²⁰, R²¹ and R²² is (C₆-C₃₀)alkyl, more typically (C₆-C₂₄)alkyl, or (C₆-C₃₀)alkenyl, more typically (C₈-C₂₄)alkenyl.

In one embodiment, the fatty glyceride comprises one or more fatty diglyceride compounds according to structure (IIa) wherein two of R²⁰, R²¹ and R²² are each independently (C₆-C₃₀)alkyl, more typically (C₆-C₂₄)alkyl, or (C₆-C₃₀)alkenyl, more typically (C₈-C₂₄)alkenyl, and the remaining one of R²⁰, R²¹ and R²² is H.

In one embodiment, the fatty glyceride comprises one or more fatty triglyceride compounds according to structure (IIa) wherein R²⁰, R²¹, and R²² are each independently (C₆-C₂₄)alkyl, more typically (C₆-C₂₄)alkyl, or (C₈-C₂₄)alkenyl, more typically (C₈-C₂₄)alkenyl. In one embodiment R²⁰, R²¹, and R²² are each independently a linear or branched (C₄-C₃₀)alkyl, more typically, linear or branched (C₈-C₂₄)alkyl, even more typically linear or branched (C₁₂-C₂₂)alkyl, or (C₅-C₂₄)cycloalkyl, or linear or branched (C₄-C₃₀)alkenyl, more typically, linear or branched (C₈-C₂₄)alkenyl, even more typically linear or branched (C₁₂-C₂₂)alkenyl, or (C₅-C₂₄)cycloalkenyl, or (C₄-C₃₀)alkaryl, more typically (C₈-C₂₄)alkaryl, or (C₄-C₃₀)aralkyl, more typically (C₈-C₂₄)aralkyl. In one embodiment, R²⁰, R²¹, and R²² are each independently a linear or branched (C₄-C₃₀)alkyl; or in another embodiment is a linear or branched (C₈-C₂₄)alkyl; or in another embodiment is a linear or branched (C₁₂-C₂₂)alkyl; or in another embodiment is a (C₅-C₂₄)cycloalkyl; or in another embodiment is a linear or branched (C₄-C₃₀)alkenyl; or in another embodiment is a linear or branched (C₈-C₂₄)alkenyl; or in another embodiment is a linear or branched (C₁₂-C₂₂)alkenyl; or in another embodiment is a (C₅-C₂₄)cycloalkenyl; or in another embodiment is a (C₄-C₃₀)alkaryl; or in another embodiment is a (C₈-C₂₄)alkaryl, or (C₄-C₃₀)aralkyl, more typically (C₈-C₂₄)aralkyl.

In one embodiment, the fatty glyceride or triglyceride comprises one or more compounds according to structure (II):

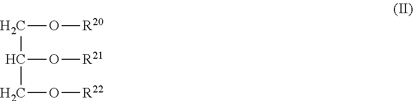

wherein:
R²⁰, R²¹, and R²² are each independently H, carboxy(C₆-C₃₀)alkyl, more typically carboxy(C₁₀-C₂₄)alkyl, or carboxy(C₆-C₃₀)alkenyl, more typically carboxy(C₁₀-C₂₄)alkenyl. In one embodiment, R²⁰, R²¹, and R²² are each independently carboxy(C₁₄-C₁₈)alkyl. In one embodiment, R²⁰, R²¹, and R²² are each independently carboxy(C₁₀-C₂₄)alkyl. In one embodiment, R²⁰, R²¹, and R²² are each independently carboxy(C₁₆-C₁₈)alkyl. In one embodiment, R²⁰, R²¹, and R²² are each independently carboxy(C₆-C₃₀)alkyl. In one embodiment, R²⁰, R²¹, and R²² are each independently carboxy(C₆-C₃₀)alkenyl. In one embodiment, R²⁰, R²¹, and R²² are each independently carboxy(C₁₀-C₂₄)alkenyl. The alkyl portions of the respective carboxyalkyl groups and the alkenyl portions of the respective carboxyalkenyl groups may each be linear or branched and may each, optionally, be substituted on one or more carbon atoms with hydroxyl, and provided that at least one of R²⁰, R²¹, and R²² is not H.

Alkyl moieties suitable as the alkyl portion of the carboxyalkyl groups of structure (II) include, for example, (C₄-C₃₀)hydrocarbon group.

Alkenyl moieties suitable as the alkenyl portion of the carboxyalkenyl groups of structure (II) may be mono-unsaturated or poly-unsaturated.

In one embodiment, the fatty glyceride comprises one or more fatty monoglyceride compounds according to structure (II) wherein two of R²⁰, R²¹ and R²² are each independently H and the remaining one of R²⁰, R²¹ and R²² is carboxy(C₆-C₃₀)alkyl, more typically carboxy(C₆-C₂₄)alkyl, or carboxy(C₆-C₃₀)alkenyl, more typically carboxy(C₈-C₂₄)alkenyl.

In one embodiment, the fatty glyceride comprises one or more fatty diglyceride compounds according to structure (II) wherein two of R²⁰, R²¹ and R²² are each independently carboxy(C₆-C₃₀)alkyl, more typically carboxy(C₆-C₂₄)alkyl, or carboxy(C₆-C₃₀)alkenyl, more typically carboxy(C₈-C₂₄)alkenyl, and the remaining one of R²⁰, R²¹ and R²² is H.

In one embodiment, the fatty glyceride comprises one or more fatty triglyceride compounds according to structure (II) wherein R²⁰, R²¹, and R²² are each independently carboxy(C₆-C₂₄)alkyl, more typically carboxy(C₆-C₂₄)alkyl, or carboxy(C₈-C₂₄)alkenyl, more typically carboxy(C₈-C₂₄)alkenyl.

In one embodiment, the fatty glyceride is a mixture comprising at least one fatty monoglyceride compound and at least one fatty diglyceride compound, or at least one fatty monoglyceride compound and at least one fatty triglyceride compound, or at least fatty diglyceride compound and at least one fatty triglyceride compound, or at least one fatty monoglyceride compound, at least one fatty diglyceride compound, and at least one fatty triglyceride compound.

Suitable sources of fatty glycerides include naturally occurring mixtures of fatty glycerides and which may further comprise one or more fatty acids, such as vegetable oils, including, for example, palm oil, soybean oil, rapeseed oil, high erucic acid rapeseed oil, sunflower seed oil, peanut oil, cottonseed oil, palm kernel oil, linseed oil, coconut oil, olive oil, safflower oil, sesame oil, tung oil, canola oil, castor oil, meadowfoam seed oil, hemp oil, as well as mixtures of such oils.

Suitable fatty acid glycol ester surfactants include glycol fatty acid monoesters and glycol fatty acid diesters, more typically mono- and di-esters of glycol s and saturated or unsaturated (C₈-C₂₂), more typically (C₁₂-C₁₈), fatty acids and mixtures thereof, even more typically mono- and di-esters of poly(ethylene glycol) or poly(propylene glycol) and saturated or unsaturated (C₈-C₂₂), more typically (C₁₂-C₁₈), fatty acids and mixtures thereof, such as for example, poly(ethylene glycol) monomyristates, poly(ethylene glycol) monostearates, poly(ethylene glycol) distearates, poly(ethylene glycol) monooleates, poly(ethylene glycol) dioleates poly(propylene glycol) monooleates, and poly(ethylene glycol) linolenates, poly(ethylene glycol) dibehenates, poly(ethylene glycol) monobehenates poly(ethylene glycol) monoerucates.

In one embodiment, the drift control agent comprises a fatty deposition control agent comprising one or more fatty glycerides, more typically vegetable oils, and one or more surfactants selected from fatty acid glycol ester surfactants.

In one particular embodiment, a concentrated composition of the invention may comprise a fatty deposition control agent as described previously in an amount greater than 1% by weight of composition, for instance in an amount ranging from 1% by weight to 50% by weight, in particular from 5% by weight to 30% by weight, for instance from 10% by weight to 25% by weight, relative to the total weight of the composition.

### Hydration Inhibitor Component

According to anyone of the invention embodiments, a composition of the invention may optionally further comprise at least one hydration inhibitor component.

As used herein, the term “hydration” in reference to the drift control agent or water soluble polymer component of the present invention means association of substituent groups, typically hydrophilic substitutent groups, such as hydroxyl groups, of the water soluble polymer with water molecules, such as water molecules of the aqueous medium through, for example, hydrogen bonding. The degree to which the drift control agent or water soluble polymer is hydrated can range from non-hydrated to completely hydrated, with degrees of partial hydration extending between the two extremes. As discussed more fully below, the drift control agent or water soluble polymer is capable of contributing to the viscosity of the composition of the present invention with the magnitude of the contribution being dependent on the degree of hydration of the water soluble polymer. The degree of hydration of the water soluble polymer can thus be characterized based on the magnitude of the contribution that the water soluble polymer makes to the viscosity of the composition:
(a) As referred to herein a “non-hydrated” water soluble polymer makes no significant contribution to the viscosity of the composition. In general, the non-hydrated water soluble polymer would be in the form of a discontinuous phase, for example, discrete particles, that is dispersed in a continuous phase of the liquid medium, ideally with no interaction between the hydrophilic substituents of the polymer and any water molecules present in the liquid medium. In the case of an aqueous medium, there will generally be at least some interaction between the hydrophilic groups of polymer and water molecules of the aqueous medium at interfaces between the phases, for example, at the outer surfaces of the particles. It is believed that in the case of a non-hydrated water soluble polymer, interaction among the hydrophilic substituent groups of the non-hydrated water soluble polymer dominates over interaction between the hydrophilic substituent groups of the polymer and any water molecules present in the aqueous medium, the polymer chains of the non-hydrated water soluble polymer are in a compact, folded conformation, and, in the case where the liquid medium is an aqueous medium, the non-hydrated water soluble polymer is not dissolved in the aqueous medium and remains in the form of a discontinuous phase dispersed in the continuous phase of the aqueous medium.
(b) As referred to herein, a “completely hydrated” water soluble polymer makes the maximum contribution to the viscosity of the composition that the water soluble polymer is capable of making. It is believed that in a completely hydrated water soluble polymer, association between the hydrophilic substituent groups of the water soluble polymer and water molecules dominates over interaction among the hydrophilic substituent groups, that the polymer chains of a completely hydrated water soluble polymer are thus in an unfolded, random coil conformation, and in the case where the liquid medium is an aqueous medium, the aqueous medium and completely hydrated water soluble polymer form a single phase, that is, the completely hydrated water soluble polymer is dissolved in the aqueous medium.
(c) As referred to herein, a “partially hydrated” water soluble polymer is a water soluble polymer wherein some of the hydrophilic substituent groups of the polymer are associated with water molecules. At a relatively low level of hydration, the partially hydrated water soluble polymer makes a relatively small contribution to the viscosity of the composition, while at a relatively high level of hydration, the viscosity contribution of a given amount of a partially hydrated water soluble polymer in a given medium approaches, but is less than, the maximum contribution that the amount of water soluble polymer is capable of making in that medium when completely hydrated. It is believed that with increasing hydration, particles of the water soluble polymer swell, an increasing number of hydrophilic substituent groups of the water soluble polymer, including hydrophilic substituent groups within the mass of swollen water soluble polymer, become associated with water molecules, and, as complete hydration is approached, the water soluble polymer chains progressively unfold and approach an unfolded, randomly coiled configuration.

“Non-hydrated” and “partially hydrated” are collectively referred to herein as “incompletely hydrated”. A “hydration inhibitor”, as referred to herein is any compound that may be added to an aqueous medium to inhibit hydration of a water soluble polymer in the aqueous medium.

The degree of hydration of the water soluble polymer can be characterized by viscosity measurements. For example, the viscosity of a given amount of a water soluble polymer, in a given amount of an aqueous medium, in the presence of a given amount of a proposed hydration inhibitor, and under given shear conditions, as described in more detail below (the “test composition”), can be compared to the viscosity of the same amount of the water soluble polymer in the same amount of the aqueous medium in the absence of the proposed hydration inhibitor (the “baseline composition”). If the viscosity of the test composition is equal to that of the baseline composition, then the water soluble polymer of the test composition is deemed to be completely hydrated (and the proposed hydration inhibitor is ineffective in the amount tested to inhibit hydration of the polymer). If the viscosity of the test composition is less than that of the baseline composition, then the water soluble polymer of the test composition is deemed to be incompletely hydrated (and the proposed hydration inhibitor is effective in the amount tested to inhibit hydration of the polymer).

In one embodiment, the incompletely hydrated water soluble polymer comprises solid particles of the water soluble polymer. The presence of such particles can be detected by various means, such as for example, by viewing a sample of the composition of the present invention under an optical microscope.

In one embodiment, the liquid medium is an aqueous liquid medium and at least a portion of the water soluble polymer is in the form of particles of the water soluble polymer. In one embodiment, the liquid medium is an aqueous liquid medium, at least a portion of the water soluble polymer is in the form of particles of the water soluble polymer, and at least a portion of such particles are dispersed, more typically suspended, in the aqueous liquid medium.

The presence of such particles in the composition of the present invention is detectable by, for example, optical microscopy.

In one embodiment, the composition of the present invention exhibits a viscosity of less than 10 Pa·s, more typically from about 0.1 to less than 10 Pa·s, and even more typically from about 0.1 to less than 5 Pa·s, at a shear rate of greater than or equal to 10 s⁻¹.

In one embodiment, the composition of the present invention exhibits a non-Newtonian “shear thinning” viscosity, that is, a viscosity that, within a given range of shear stress, decreases with increasing shear stress. Two general generally recognized categories of flow behavior, that is, plastic flow behavior and pseudoplastic flow behavior, each include shear thinning flow behavior.

In one embodiment, the composition of the present invention exhibits plastic flow behavior. As used herein, the term “plastic” in reference to flow behavior of a composition means the composition that exhibits a characteristic “yield strength”, that is, a minimum shear stress required to initiate flow of the composition, and exhibits shear thinning behavior over some range of shear stress above the yield strength. A plastic composition exhibits no flow when subjected to shear stress below its yield strength, and flows when subjected to shear stress above its yield strength, wherein, over an intermediate range of shear stress above its yield strength, the composition typically exhibits a non-Newtonian viscosity that decreases with increasing shear stress, that is, shear thinning behavior, and, at shear stresses above the intermediate range of shear stress, the composition may exhibit a viscosity that does not vary with shear stress, that is, Newtonian flow behavior.

In one embodiment the composition of the present invention exhibits pseudoplastic flow behavior. As used herein, the term “pseudoplastic” in reference to the flow behavior of a composition means that the composition exhibits a viscosity that decreases with increasing shear stress, that is, shear thinning behavior.

In each case, a composition having plastic or pseudoplastic rheological properties resists flow at low shear stress, but that when subjected to an elevated shear stress, such as being shaken in a bottle or squeezed through an orifice, the composition flows and can be easily pumped, poured, or otherwise dispensed from a container. In general, sedimentation or storage condition is a low shear process, having a shear rate in the range of from about 10⁻⁶ reciprocal seconds (1/s or, equivalently, s⁻¹) to about 0.01 s⁻¹ and pumping or pouring is a relatively high shear process with a shear rate in the range of greater than or equal to about 1 s⁻¹, more typically from 100 s⁻¹ to 10,000 s⁻¹, and even more typically, from 100 s⁻¹ to 1,000 s⁻¹.

In one embodiment, the hydration inhibitor is selected from surfactants, water soluble non-surfactant salts, water dispersible organic liquids, and mixtures thereof. The terminology “non-surfactant salts” as used herein means salts that are not anionic, cationic, zwitterionic or amphoteric surfactants includes active ingredients, such as pesticide salts, whose primary activity is other than modification of interfacial surface tension. The terminology “water dispersible organic liquids” includes water miscible organic liquids and water immiscible organic liquids that may be dispersed in water, such as for example, in the form of an emulsion of the water immiscible organic liquid in water. In one embodiment, the hydration inhibitor or hydration inhibitor component comprises a water dispersible organic liquid. Suitable water dispersible organic liquids include, for example, (C1-C18)alcohols, such as, for example, monohydric alcohols, such as methanol, ethanol, isopropanol, cetyl alcohol, stearyl alcohol, benzyl alcohol, oleyl alcohol, and polyhydric alcohols, such as, for example, 2-butoxyethanol, ethylene glycol, and glycerol, alkylether diols such as, for example, ethylene glycol monoethyl ether, propylene glycol monoethyl ether, and diethylene glycol monomethyl ether, and mixtures thereof.

In one embodiment, the hydration inhibitor component comprises choline chloride. In one embodiment, the hydration inhibitor is selected from glycol, a glycol derivative, a glycerol, a glycerol derivative, or any combination thereof.

Glycols, glycol derivatives, glycerols and/or glycerol derivatives include, but are not limited, to polyglycols, polyglycol derivatives, aliphatic dihydroxy (dihydric) alcohols, polypropylene glycol, triethylene glycol, glycol alkyl ethers such as dipropylene glycol methyl ether, diethylene glycol. In another embodiment, glycols, glycol derivatives, glycerols and/or glycerol derivatives include but are not limited to polyglycols such as polyethylene glycols (PEG) and polypropylene glycols. Glycols are represented by the general formula CnH2n(OH)2, where n is at least 2. Non-limiting examples of glycols include ethylene glycol (glycol), propylene glycol (1,2-propanediol), 1,4-butanediol, 1,5-pentanediol, 1,6-hexanediol, 1,7-heptanediol, 1,9-nonanediol, 1,10-decanediol, 1,8-octanediol, 1,3-propanediol, 1,3-butanediol, 1,4-butanediol, 2,3-butanediol, 2,4-pentanediol, 2,5-hexanediol, 4,5-octanediol and 3,4-hexanediol, neopenty glycol, pinacol, 2,2-diethyl-1,3-propanediol, 2-ethyl-1,3-hexanediol, 2-ethyl-2-butyl-1,3-propanediol, isobutylene glycol, 2,3-dimethyl-1,3-propanediol, 1,3-diphenyl-1,3-propanediol, 3-methyl-1,3-butanediol.

In another embodiment, glycols, glycol derivatives, glycerols and/or glycerol derivatives include but are not limited to glycol stearate, ethylene glycol monostearate, ethylene glycol distearate, ethylene glycol amido stearate, dilaurate glycol, propylene glycol monostearate, propylene glycol dicaprylate, propylene glycol dicaprate diacetate glycol, dipalmite glycol, diformate glycol, dibutyrate glycol, dibenzorate glycol, dipalmate glycol, dipropionate glycol, monoacetate glycol, monopalmitate glycol and monoformate glycol. In another embodiment, glycols, glycol derivatives, glycerols and/or glycerol derivatives also include polypropylene glycol, triethylene glycol, dipropylene glycol methyl ether, or diethylene glycol.

Polyglycol derivatives include but are not limited to polypropylene glycols, as well as polyethylene glycol (PEG) 200-6000 mono and dilaurates, such as, PEG 600 dilaurate, PEG 600 monolaurate, PEG 1000 dilaurate, PEG 1000 monolaurate, PEG 1540 dilaurate and PEG 1540 monolaurate, polyethylene glycol 200-6000 mono and dioleates, such as, PEG 400 monoleate, PEG 600 dioleate, PEG 600 monooleate, PEG 1000 monoleate, PEG 1540 dioleate, PEG 1540 monooleate and polyethylene glycol 200-6000 mono and distearates, such as, PEG 400 distearate, PEG 400 monostearate, PEG 600 distearate, PEG 600 monostearate, PEG 1000 distearate, PEG 1000 monostearate, PEG 1540 distearate, PEG 1540 monostearate and PEG 3000 monostearate.

Examples of glycerol derivatives include but are not limited to glycerol monolaurate, glycerol monostearate, glycerol distearate, glycerol trioleate, glycerol monooleate, glycerol dilaurate, glycerol dipalmitate, glycerol triacetate, glycerol tribenzoate, glycerol tributyrate, glycerol monopalmitate, glycerol trimyristate, glycerol trilaurate, glycerol tripalmitate and glycerol tristearate.

In one embodiment, the composition of the present invention exhibits a viscosity of less than 10 Pa·s, more typically from about 0.1 to less than 10 Pa·s, at a shear rate of greater than or equal to 10 s⁻¹. In one embodiment, the composition of the present invention exhibits a viscosity of less than 7 Pa·s, more typically from about 0.1 to less than 7 Pa·s, at a shear rate of greater than or equal to 10 s⁻¹. In one embodiment, the composition of the present invention exhibits a viscosity of less than 5 Pa·s, more typically from about 0.1 to less than 5 Pa·s, at a shear rate of greater than or equal to 10 s⁻¹.

In one embodiment, such a viscosity profile equates to the composition being flowable, i.e., able to be pumped. This characteristic is an advantage as end use applications from a storage container typically prefer to pump components into the final application tank for crop application. For example, typically farmers will add components for a final tank mix into separate tanks, such as a tank for water, a tank for an adjuvant composition, a tank for a water conditioner, and have those components pumped into a final end use application tank.

In one embodiment, the composition of the present invention is prepared on an as needed basis and is sufficiently stable, that is, a quiescent sample of the composition shows no evidence, by visual inspection, of gravity driven separation, such as, separation into layers and/or precipitation of components, such as, for example, separation of incompletely hydrated water-soluble polymer from the liquid medium, within the anticipated time period.

In one embodiment, the composition of the present invention exhibits good storage stability and a quiescent sample of the composition shows no evidence, by visual inspection, of gravity driven separation within a given time, such as, for example, one week, more typically, one month, even more typically 3 months, under given storage conditions, such as, for example, at room temperature. In another embodiment, the composition of the present invention exhibits good storage stability and a quiescent sample of the composition shows no evidence, by visual inspection, of gravity driven separation within a given time, which in one embodiment is one week, more typically, one month, even more typically 3 months, under high temperature storage conditions, e.g., greater than 50° C. In one embodiment, the composition of the present invention is shelf stable (i.e., exhibits at least part of the good storage stability as detailed above) at a temperature greater than 50° C. for at least 24 hours, or 48 hours, or in yet another embodiment, 72 hours.

In one embodiment, the composition of the present invention exhibits good storage stability and a quiescent sample of the composition shows no evidence, by visual inspection, of gravity driven separation within a given time, such as, for example, 24 hours, more typically, four days, even more typically, one week, under accelerated aging conditions at an elevated storage temperature of up to, for example, 54° C., more typically, 45° C.

In one embodiment, a concentrated composition of the invention exhibits a Brookfield viscosity at 25° C. and at 20 rpm of less than or equal to about 5,000 centiPoise (“cP”), more typically of less than or equal to 2,500 cP, for example from about 10 to about 1,500, especially from about 10 to about 1,000 cP.

A concentrated composition of the invention exhibits good storage stability. The criteria for assessing storage stability are that the formulation remains substantially homogeneous in visual appearance during storage and does not separate into layers of mutually insoluble liquid phases and does not form any solid precipitate upon quiescent standing

In one embodiment, the concentrated composition of the invention remains stable during storage at temperatures from −5° C. to 54° C. for greater than or equal to 7 days, more typically for greater than or equal to 14 days (adaptation of CIPAC test MT46.3).

The concentrated composition of the invention remains stable during storage at room temperature for more than or equal to 7 days, more typically for greater than or equal to 14 days and even more typically for greater than or equal to 30 days.

A concentrated composition of the invention also exhibits good dilution stability and/or provides a suitable dispersion.

The term “suitable dispersion” is intended to denote a dispersion after dilution in water (CIPAC standard waters A or D) which exhibits substantially no or little phase separation (sedimentation, creaming, etc)) over time, in particular when it is stored for 30 minutes in a water bath thermostatted at 30° C., preferably for 2 hours in a water bath thermostatted at 30° C. and ideally for 24 hours in a water bath thermostatted at 30° C. (adaptation of CIPAC test MT41 and MT184).

The concentrated composition of the invention may comprise additional pesticides in addition to the auxin herbicide.

Suitable additional pesticides are pesticides as defined below. Preferred additional pesticides are herbicides, such as
amino acid derivatives: bilanafos, glyphosate (e.g. glyphosate free acid, glyphosate ammonium salt, glyphosate isopropylammonium salt, glyphosate trimethylsulfonium salt, glyphosate potassium salt, glyphosate dimethylamine salt), glufosinate (e.g. glufosinate ammonium salt), sulfosate;
imidazolinones: imazamethabenz, imazamox, imazapic, imazapyr, imazaquin, imazethapyr;
phenoxy acetic acids: clomeprop, 2,4-dichlorophenoxyacetic acid (2,4-D), 2,4-DB, dichlor-prop, MCPA, MCPA-thioethyl, MCPB, Mecoprop.

More preferred additional pesticides are glyphosate and glufosinate.

According to anyone of the invention embodiments, a concentrated composition of the invention may comprise, in addition to said water-soluble salt of an auxin herbicide, at least one water-soluble salt of at least one additional herbicide.

For instance, a concentrated composition of the invention may further comprise at least one water-soluble salt of glyphosate and/or at least one water-soluble salt of glufosinate.

According to anyone of the invention embodiments, the total amount of water-soluble salts (whether it be a water-soluble salt of said auxin herbicide alone or a combination of a water-soluble salt of said auxin herbicide with a water-soluble salt of an additional herbicide and/or with added water-soluble salt) may be of at least 300 g/L.

According to anyone of the invention embodiments, a concentrated composition of the invention may also comprise, in addition to said water-soluble salt of an auxin herbicide, at least one additional herbicide which is insoluble in said concentrated composition, for instance present in a dispersed form.

According to another one of the invention embodiments, a concentrated composition of the invention may also comprise, in addition to said water-soluble salt of an auxin herbicide, at least one additional herbicide present in a soluble form in a liquid medium different from the aqueous continuous phase and which is non-miscible in said aqueous phase, with said liquid medium being present in an emulsified form in said concentrated composition. Suspoemulsions are typical examples of such compositions.

The concentrated composition of the invention may comprise auxiliaries, such as volatilization reduction additives, solvents, liquid carriers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants.

Suitable solvents and liquid carriers are organic solvents, such as mineral oil fractions of medium to high boiling point, e.g. kerosene, diesel oil; oils of vegetable or animal origin; aliphatic, cyclic and aromatic hydrocarbons, e. g. toluene, paraffin, tetrahydronaphthalene, alkylated naphthalenes; alcohols, e.g. ethanol, propanol, butanol, benzylalcohol, cyclohexanol; glycols; DMSO; ketones, e.g. cyclohexanone; esters, e.g. lactates, carbonates, fatty acid esters, gamma-butyrolactone; fatty acids; phosphonates; amines; amides, e.g. N-methylpyrrolidone, fatty acid dimethylamides; and mixtures thereof.

Suitable surfactants are surface-active compounds, such as anionic, cationic, nonionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides.

Examples of sugar-based surfactants are sorbitans, ethoxylated sorbitans, sucrose and glucose esters or alkylpolyglucosides. Examples of polymeric surfactants are homo- or copolymers of vinylpyrrolidone, vinylalcohols, or vinylacetate. The alkoxylate of the formula (1) is not a nonionic surfactant within the meaning of this invention. Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a negligible or even no pesticidal activity themselves, and which improve the biological performance of the compound I on the target. Examples are surfactants, mineral or vegetable oils, and other auxilaries. Further examples are listed by Knowles, Adjuvants and additives, Agrow Reports DS256, T&F Informa UK, 2006, chapter 5.

Suitable thickeners are for instance polysaccharides (e.g. xanthan gum, carboxymethylcellulose), anorganic clays (organically modified or unmodified), polycarboxylates, and silicates.

Suitable bactericides are bronopol and isothiazolinone derivatives such as alkylisothiazolinones, alkylchloroisothiazolinones and benzisothiazolinones.

Suitable anti-freezing agents are ethylene glycol, propylene glycol, urea and glycerin. Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

In one embodiment, the composition of the invention is free or substantially free of ammonium-containing water conditioning agent, in particular ammonium sulfate.

In one embodiment, the composition is concentrated blend of a at least one an auxin herbicide or salt thereof, a drift control agent and suspending agent as defined previously, which composition is stable, has a low viscosity, is easily transportable, is pourable and pumpable under field conditions, and is dilutable with water under field conditions to form a dilute pesticide composition for spray application to target pests.

In one embodiment, the concentrated pesticide composition of the present invention is diluted with water, typically in a ratio of from 1:10 to 1:1,000 parts by weight pesticide concentrate composition: parts by weight water, for instance in a ratio of from 1:10 to 1:100 parts by weight pesticide concentrate composition: parts by weight water to form a dilute pesticide composition for spray application to target plants.

Optionally, other components, such as additional pesticide, polymer, surfactants, fertilizer, and/or other adjuvants, may be added to the dilute pesticide composition.

In one embodiment, the pesticide composition of the present invention is applied, in dilute form, to foliage of a target plant at a rate of from about 0.25 pint, more typically about 0.5 pint, to about 5 pints, even more typically from about 1 pint to about 4 pints, as expressed in terms of the above described pesticide concentrate embodiment of the pesticide composition of the present invention (that is, comprising, based on 100 pbw of such composition, up to about 70 pbw, more typically from about 10 to about 60 pbw, more typically from about 25 to about 55 pbw, pesticide) per acre.

In one embodiment, the pesticide composition is spray applied in dilute form via conventional spray apparatus to foliage of one or more target plants present on an area of ground at a rate of from about 1 gallon to about 20 gallons, more typically about 3 gallons to 20 gallons, of the above described diluted pesticide composition per acre of ground.

The pesticide compositions of the invention may advantageously also be useful to reduce volatility of said auxin herbicide and off-site movement of said auxin herbicide.

Volatilization occurs when pesticide surface residues change from a solid or liquid to a gas or vapor after an application of a pesticide has occurred. Once airborne, volatile pesticides can move long distances off site (and in particular longer distances compared to spray drift).

Another object of the present invention is to provide auxin herbicide compositions having reduced volatility relative to currently available compositions, and preferably reduced-volatility compositions that exhibit no significant reduction in herbicidal effectiveness relative to currently available compositions.

Advantageously, it is believed that the compositions of the present invention provide enhanced protection from off-target crop injury while maintaining comparable herbicidal efficacy on auxin-susceptible plants located in the target area.

Impact on the auxin herbicide volatility can be measured by conventional means known to those skilled in the art.

For instance, volatilization of an auxin herbicide can be assessed as follows: an auxin herbicide composition is heated, causing the auxin herbicide to volatilize from said composition into the gas phase. Weight of residual auxin herbicide composition is recorded against time (through thermogravimetric analyses), allowing indirect measurement of volatilization of the auxin herbicide.

Some details or advantages of the invention will appear in the non-limitative examples below.

### EXAMPLES

### Example 1 and Comparative Example C1

The composition of Example 1 was an aqueous herbicide composition that contained a pesticide (N,N-bis(3-aminopropyl)methylamine salt of Dicamba), a polyethylene glycol (polyethylene glycol 400), a salt (Choline Chloride), a water soluble polysaccharide polymer (non-derivatized guar) and a suspending agent (hydrophobic fumed silica). The composition of Comparative Example 1 was analogous to that of Example 1, but with another suspending agent (hydrophilic fumed silica).

The compositions were prepared as follows. During all the preparation, the medium was stirred using an inox deflocculating blade (diameter 35 mm) at a speed of 700 rpm. 81.28% wt. Engenia™ (N,N-bis(3-aminopropyl)methylamine salt of Dicamba, 600 g/L a.e. BASF) were introduced in a plastic beaker. 0.01% wt. preservative (Kathon CG™, Dow) were added, followed by 2.33% wt. Choline Chloride salt (Alfa Aesar) and 9.35% wt. polyethylene glycol (Carbowax PEG 400 E™, Dow). Then 2.03% wt. suspending agent (Aerosil R974™ Evonik DeGussa) were slowly added (gentle sprinkling using a spatula). The formulation was then left for 3 hours under stirring (700 rpm). Then 5% wt. non-derivatized guar gum (having a weight average molecular weight of about 2,000,000 g/mol) were slowly introduced (gentle sprinkling using a spatula). The formulation was then left for 1 hour under stirring (700 rpm). The comparative Example 1 was prepared in the same fashion of Example 1.

The stability of each of the compositions was evaluated by allowing a sample of the composition to sit undisturbed in a 100 milliLiter (mL) glass vial under hot conditions (54° C., oven) and visually observing the composition to detect viscosity increase and/or separation of the components of the composition due to gravity. Separation of the components of the composition and significant viscosity increase were taken as evidence of instability. Compositions that did not exhibit separation within a given period of time were characterized as being stable for that period of time. Compositions that are easily pourable were characterized as being stable for that period of time. Comparative example C1 was not stable as it was not pourable after 2 weeks at 54° C. Example 1 was stable and showed no evidence of viscosity increase and precipitation or separation into layers for 2 weeks at 54° C.

The viscosity of each of the compositions was measured at room temperature using a Brookfield LV viscometer equipped with a SP62 spindle or SSA Low volume, SC4-21 spindle at 20 revolutions per minute (“rpm”).

Samples of the compositions of Example 1 and comparative Example 1 were diluted with water CIPAC D (342 ppm) at 30° C.

The materials and their relative amounts used to make the compositions of Examples 1 and C1 are set forth in Table I below and the stability and dilution results for Example 1 and Comparative Example C1 are set forth in Table I-A below.

TABLE I
Concentrated aqueous BAPMA Dicamba herbicide compositions.

| | EX 1 | CEX1 |
|---|---|---|
| Materials | % wt. | % wt. |
| Aqueous solution of | 81.28 | 81.28 |
| N,N-bis(3-aminopropyl)methylamine | | |
| salt of Dicamba (Engenia ™) | | |
| Preservative (Kathon CG ™, Dow)) | 0.01 | 0.02 |
| Choline chloride (Alfa Aesar) | 2.33 | 2.34 |
| Carbowax PEG 400 E ™, Dow | 9.35 | 9.31 |
| suspending agent | 2.03 | — |
| (Aerosil R974 , Evonik DeGussa) | | |
| suspending agent | — | 2.05 |
| (Aerosil 200, Evonik DeGussa) | | |
| Non-derivatized guar (Solvay) | 5.00 | 5.00 |

TABLE I-A

| | | EX1 | | CEX1 |
|---|---|---|---|---|
| Before storage | Viscosity | 500 cP (SP62) | | 300 cP |
| | (Brookfield LV, | | | (SSA Low |
| | @RT) | | | volume, SC4-21) |
| | Dilution | Acceptable | | Acceptable |
| | (1% in CIPAC | dispersibility | | dispersibility |
| | D 30° C.) 2 h | | | |
| After storage | Aspect | Stable | | Non stable |
| 54° C. 2 weeks | | | | (very difficult |
| | | | | to pour) |
| | Viscosity | 720 | cP | gel - not |
| | (Brookfield LV, | | | measured |
| | 20 rpm, SP62 @RT) | | | |

RT = Room Temperature

### Example 2 and Comparative Example C2

The composition of Example 2 was an aqueous herbicide composition that contained a pesticide (N,N-bis(3-aminopropyl)methylamine salt of Dicamba), polyethylene glycol (polyethylene glycol 400), a salt (Choline Chloride), a water soluble polyacrylamide polymer and a suspending agent (hydrophobic fumed silica). The composition of Comparative Example 2 was analogous to that of Example 2, but with another suspending agent (hydrophilic fumed silica).

The compositions were prepared as follows. During all the preparation, the medium was stirred using an inox deflocculating blade (diameter 35 mm) at a speed of 800 rpm. 84.69% wt. Engenia™ (N,N-bis(3-aminopropyl)methylamine salt of Dicamba, 600 g/L a.e. BAS) were introduced in aplastic beaker. 0.1% wt. preservative (Kathon CG™, Dow) were added, followed by 2.43% wt. Choline Chloride salt (Alfa Aesar) and 9.75% wt. polyethylene glycol (Carbowax PEG 400 E™, Dow). Then 2.12% wt. suspending agent (Aerosil R974™, Evonik DeGussa) were slowly added (gentle sprinkling using a spatula). The formulation was then left for 3 hours under stirring (800 rpm). Then 1.00% wt. partially hydrolyzed polyacrylamide HPAM (Flopaam 3330S™, SNF) were slowly introduced (gentle sprinkling using a spatula). The formulation was then left for 1 hour under stirring (800 rpm) followed by 2 minutes of UltraTurrax (IKA T25 basic, 13500 rpm, 12.7 mm rotor diameter). The comparative Example 2 was prepared in the same fashion of Example 2.

The stability of each of the compositions was evaluated by allowing a sample of the composition to sit undisturbed in a 100 milliLiter (mL) glass vial under hot conditions (54° C., oven) and visually observing the composition to detect viscosity increase and/or separation of the components of the composition due to gravity. Separation of the components of the composition and significant viscosity increase were taken as evidence of instability. Compositions that did not exhibit separation within a given period of time were characterized as being stable for that period of time. Compositions that are easily pourable were characterized as being stable for that period of time. Comparative example C2 was not stable as it was not pourable after 2 weeks at 54° C. Example 2 was stable and showed no evidence of viscosity increase and precipitation or separation into layers for 2 weeks at 54° C.

The viscosity of each of the compositions was measured at room temperature using a Brookfield LV viscometer equipped with a SSA Low volume, SC4-21 spindle at 5 revolutions per minute (“rpm”).

The materials and their relative amounts used to make the compositions of Examples 2 and C2 are set forth in Table I below and the stability results for Example 2 and Comparative Example C2 are set forth in Table I-A below.

TABLE II
Concentrated aqueous BAPMA Dicamba herbicide compositions.

| | EX 2 | CEX2 |
|---|---|---|
| Materials | % wt. | % wt. |
| Aqueous solution of | 84.69 | 84.61 |
| N,N-bis(3-aminopropyl)methylamine | | |
| salt of Dicamba (Engenia ™) | | |
| Preservative (Kathon CG ™, Dow)) | 0.01 | 0.02 |
| Choline chloride (Alfa Aesar) | 2.43 | 2.43 |
| Carbowax PEG 400 E ™, Dow | 9.75 | 9.69 |
| suspending agent | 2.12 | — |
| (Aerosil R974 , Evonik DeGussa) | | |
| suspending agent | — | 2.14 |
| (Aerosil 200, Evonik DeGussa) | | |
| Co-polymer of acrylamide and acrylate | 1.00 | 1.11 |
| (Flopaam 3330S ™, SNF) | | |

TABLE II-A

| | | EX 2 | | CEX2 |
|---|---|---|---|---|
| Before storage | Viscosity | 300 | cP | Viscosity > |
| | (Brookfield LV, | | | 5,000 cP |
| | SSA low volume, | | | |
| | 5 rpm, SC4-21 @RT) | | | |
| After storage | Aspect | Stable | | Not stable (gel) |
| 54° C. 2 weeks | Viscosity | 110 | cP | — |
| | (Brookfield LV, | | | |
| | SSA low volume, | | | |
| | 5 rpm, SC4-21 @RT) | | | |

RT = Room Temperature

### Example 3 and Comparative Example C3

The composition of Example 3 was an aqueous herbicide composition that contained a pesticide (N,N-bis(3-aminopropyl)methylamine salt of Dicamba), a fatty drift control agent and a suspending agent (hydrophobic fumed silica). The composition of Comparative Example 3 was analogous to that of Example 3, but with another suspending agent (hydrophilic fumed silica).

The composition of the fatty drift control agent was prepared as follows. Fatty drift control agent was made by blending 85% wt. fatty deposition control agent (Soybean oil) and 15% wt. surfactant (an ethoxylated fatty acid, Alkamuls VO/2003, Solvay).

The compositions were prepared as follows. During all the preparation, the medium was stirred using an inox deflocculating blade (diameter 35 mm) at a speed of 800 rpm. 82.99% wt. Engenia™ (N,N-bis(3-aminopropyl)methylamine salt of Dicamba, 600 g/L a.e. BASF) were introduced in a plastic beaker. 0.02% wt. preservative (Kathon CG™, Dow) were added. Then 1.98% wt. suspending agent (Aerosil R974™, Evonik DeGussa) were slowly added (gentle sprinkling using a spatula). The formulation was homogeneized during 2 minutes 30 s with UltraTurrax (IKA T25 basic, 13500 rpm, 12.7 mm rotor diameter) and with stirring during 2 hours (800 rpm). Then 15.01% wt. fatty drift control agent were slowly introduced. The formulation was then left for 1.5 hours under stirring (800 rpm).

The comparative Example 3 was prepared in the same fashion of Example 3.

The stability of each of the compositions was evaluated by allowing a sample of the composition to sit undisturbed in a 100 milliLiter (mL) glass vial under hot conditions (54° C., oven) and visually observing the composition to detect viscosity increase and/or separation of the components of the composition due to gravity. Separation of the components of the composition and significant viscosity increase were taken as evidence of instability.

Compositions that did not exhibit separation within a given period of time were characterized as being stable for that period of time. Compositions that are easily pourable were characterized as being stable for that period of time. Comparative example C3 was not stable as it was not pourable after 2 weeks at 54° C. Example 3 was stable and showed no evidence of viscosity increase and precipitation or separation into layers for 2 weeks at 54° C.

The viscosity of each of the compositions was measured at room temperature using a Brookfield LV viscometer equipped with a SSA Low volume, SC4-28 spindle at 20 revolutions per minute (“rpm”).

The materials and their relative amounts used to make the compositions of Examples 3 and C3 are set forth in Table III below and the stability results for Example 3 and Comparative Example C3 are set forth in Table III-A below.

TABLE III
Concentrated aqueous BAPMA Dicamba herbicide compositions.

| | EX 3 | CEX3 |
|---|---|---|
| Materials | % wt. | % wt. |
| Aqueous solution of | 82.99 | 82.85 |
| N,N-bis(3-aminopropyl)methylamine | | |
| salt of Dicamba (Engenia ™) | | |
| Preservative (Kathon CG ™, Dow)) | 0.02 | 0.04 |
| suspending agent | 1.98 | — |
| (Aerosil R974 , Evonik DeGussa) | | |
| suspending agent | — | 2.08 |
| (Aerosil 200, Evonik DeGussa) | | |
| fatty drift control agent (Solvay) | 15.01 | 15.03 |

TABLE III-A

| | | EX 3 | | CEX3 | |
|---|---|---|---|---|---|
| Before storage | Viscosity RT | 1700 | cP | 4600 | cP |
| | (Brookfield LV, | | | | |
| | SSA low volume SC4-28) | | | | |

| After storage | Aspect | Stable | | Not stable |
|---|---|---|---|---|
| 54° C. 2 weeks | | | | 20% bottom |
| | | | | syneresis |
| | Viscosity RT | 1630 | cP | — |
| | (Brookfield LV, | | | |
| | SSA low volume SC4-28) | | | |

RT = Room Temperature

### Example 1 and Comparative Example C4

The composition of Example 1 was an aqueous herbicide composition that contained a pesticide (N,N-bis(3-aminopropyl)methylamine salt of Dicamba), polyethylene glycol (polyethylene glycol 400), a salt (Choline Chloride), a water soluble polysaccharide polymer (non-derivatized guar) and a suspending agent (hydrophobic fumed silica). The composition of Comparative Example 4 was analogous to that of Example 1, but with another suspending agent (Xanthan gum).

The composition of the Comparative Example C4 was prepared as follows. During all the preparation, the medium was stirred using an inox deflocculating blade (diameter 35 mm) at a speed of 700 rpm. 94.81% wt. Engenia™ (N,N-bis(3-aminopropyl)methylamine salt of Dicamba, 600 g/L a.e. BASF) were introduced in a plastic beaker. 0.06% wt. preservative (Kathon CG™, Dow) were added. Then 0.10% wt. suspending agent (Xanthan Gum, Rhodopol 23, Solvay) were slowly added (gentle sprinkling using a spatula). The formulation was then left for 3 hours under stirring (700 rpm). Then 5.03% wt. non-derivatized guar gum (having a weight average molecular weight of about 2,000,000 g/mol) were slowly introduced (gentle sprinkling using a spatula). The formulation was then left for 1 hour under stirring (700 rpm).

The stability of each of the compositions was evaluated by allowing a sample of the composition to sit undisturbed in a 100 milliLiter (mL) glass vial under hot conditions (54° C., oven) and visually observing the composition to detect viscosity increase and/or separation of the components of the composition due to gravity. Separation of the components of the composition and significant viscosity increase were taken as evidence of instability. Compositions that did not exhibit separation within a given period of time were characterized as being stable for that period of time. Compositions that are easily pourable were characterized as being stable for that period of time. Comparative example C4 was not stable as two phases appeared after 4 days at 54° C. Example 1 was stable and showed no evidence of viscosity increase and precipitation or separation into layers for 2 weeks at 54° C.

The viscosity of each of the compositions was measured at room temperature using a Brookfield LV viscometer equipped with a SP62 spindle at 20 revolutions per minute (“rpm”).

Samples of the compositions of Example 1 were diluted with water CIPAC D (342 ppm) at 30° C.

The materials and their relative amounts used to make the compositions of Examples 1 and C4 are set forth in Table IV below and the stability and dilution results for Example 1 and Comparative Example C4 are set forth in Table IV-A below.

TABLE IV
Concentrated aqueous BAPMA Dicamba herbicide compositions.

| | EX1 | CEX4 |
|---|---|---|
| Materials | % wt. | % wt. |
| Aqueous solution of | 81.28 | 94.81 |
| N,N-bis(3-aminopropyl)methylamine | | |
| salt of Dicamba (Engenia ™) | | |
| Preservative (Kathon CG ™, Dow)) | 0.01 | 0.06 |
| Choline chloride (Alfa Aesar) | 2.33 | — |
| Carbowax PEG 400 E ™, Dow | 9.35 | — |
| suspending agent | 2.03 | — |
| (Aerosil R974 , Evonik DeGussa) | | |
| suspending agent | — | 0.10 |
| (Rhodopol 23, Solvay) | | |
| Non-derivatized guar (Solvay) | 5.00 | 5.03 |

TABLE IV-A

| | | EX1 | | CEX4 | |
|---|---|---|---|---|---|
| Before storage | Viscosity | 500 | cP | 780 | cP |
| | (Brookfield LV, | | | | |
| | 20 rpm, SP62 @RT) | | | | |

| | | | |
|---|---|---|---|
| | Dilution | Acceptable | Acceptable |
| | (1% in CIPAC D | dispersibility | dispersibility |
| | 30° C.) 2 h | | |
| After storage | Aspect | 2 weeks: Stable | 4 days: 25% |
| | | | top separation |
| 54° C. | Viscosity | 2 weeks: 720 cP | — |
| | (Brookfield LV, | | |
| | 20 rpm, SP62 @RT) | | |

RT = Room Temperature

### Drift Measurements

The aqueous spray compositions of Example 1 and Engenia™ were made by diluting compositions Example 1 and Engenia™ (BAS) in 342 ppm hardness CIPAC water to provide dilute aqueous mixtures containing the relative amount of the respective compositions Example 1 and Engenia™ as percent by weight of the dilute composition in Table V below.

The dilute aqueous compositions thus obtained were sprayed through a single flat fan nozzle AI11003-VS at a pressure of 40 psi in a flow-controlled hood (speed 1.6 mph) and the droplet size distribution was measured perpendicular to the plane pf spray pattern and 12 inches below the nozzle tip. A Sympatec Laser HELOS-VARIO/KR multi range (Sympatec GmbH, Germany) was used to measure the spray droplets using a R7 lens.

Two parameters V<150 (% of volume of spray droplets of less than 150 microns (i.e., representative of driftable fines)) and VMD (Volume Median Diameter (defined as the droplet size below which 50% volume of spray is contained)) are reported in the Table V.

The spray compositions of Example 1 exhibited a smaller amount of small size spray droplets that are very susceptible to spray drift, i.e. below 150 μm in size, compared to respective analogous compositions of Engenia™.

TABLE V

| | g/L a.e. | ppm non- | | |
|---|---|---|---|---|
| | Dicamba | derivatized | V < | |
| | in dilute | guar in dilute | 150 μm | VMD |
| | composition | composition | (%) | (μm) |
| 0.8% wt. Engenia ™ | 4.80 | 0 | 10.97 | 425.47 |
| 1% wt. Engenia ™ | 6.00 | 0 | 11.01 | 425.04 |
| 1% wt. Example 1 | 4.87 | 500 | 4.88 | 646.77 |
| 1.2% wt. Example 1 | 5.85 | 600 | 4.15 | 680.72 |

### Example 5

The composition of Example 5 was an aqueous herbicide composition that contained a pesticide (Diglycolamine salt of Dicamba), a water soluble polysaccharide polymer (non-derivatized guar) and a suspending agent (hydrophobic fumed silica).

SL DGA Dicamba was prepared as follows.

### Preparation of Diluted Solution of DGA:

41.8% wt. deionized water were introduced in a glass bottle of 500 mL. 58.2% wt. DGA (DiGlycolAmine, 98%, Merck) were added into the water. The solution was stirred (magnetic stirrer, 700 rpm) during 45 min.

### Preparation of SL DGA Dicamba:

43.1% wt. diluted solution of DGA were introduced in a glass bottle of 1 L. 55.9% wt. acid dicamba (92.5% active content) were added slowly under magnetic stirring (400 rpm), followed by addition of 1.00% wt. water. The mixture is stirred during 1 hour at 700 rpm (targeted value of pH: 6).

The composition was prepared as follows. During all the preparation, the medium was stirred using an inox deflocculating blade (diameter 35 mm) at a speed of 700 rpm. 75.4% wt. Diglycolamine salt of Dicamba were introduced in a plastic beaker. 0.01% wt. preservative (Kathon CG™, Dow) were added, followed by 2.3% wt. Choline Chloride salt (Alfa Aesar) and 9.3% wt. of polyethylene glycol (Carbowax PEG 400 E™, Dow). Then 2.0% wt. suspending agent (Aerosil R974™, Evonik DeGussa) were slowly added. The formulation was left for 3 hours under stirring (700 rpm). Then 5% wt. non-derivatized guar gum (having a weight average molecular weight of about 2,000,000 g/mol) were slowly introduced (gentle sprinkling using a spatula) followed by addition of 6% wt. water. The formulation was then left for 1 hour under stirring (700 rpm).

The stability of the composition was evaluated by allowing a sample of the composition to sit undisturbed in a 100 milliLiter (mL) glass vial under hot conditions (54° C., oven) and visually observing the composition to detect viscosity increase and/or separation of the components of the composition due to gravity. Separation of the components of the composition and significant viscosity increase were taken as evidence of instability. Compositions that did not exhibit separation within a given period of time were characterized as being stable for that period of time. Compositions that are easily pourable were characterized as being stable for that period of time.

Example 5 was stable and showed no evidence of viscosity increase nor precipitation or phase separation after 2 weeks at room temperature (little phase separation was observed after 2 weeks at 54° C. Sample was easy to re-homogenize).

The viscosity of the Example 5 was measured at room temperature using a Brookfield LV viscometer equipped with a SP62 spindle or SSA Low volume, SC4-21 spindle at 20 revolutions per minute (“rpm”).

Samples of the composition of Example 5 was diluted with water CIPAC D (342 ppm) at 30° C.

The materials and their relative amounts used to make the composition of Example 5 are set forth in Table VI below and the stability and dilution results for Example 5 a are set forth in Table VI-A below.

TABLE VI
Concentrated aqueous DGA Dicamba herbicide compositions

| | EX 5 |
|---|---|
| Materials | % wt. |
| Aqueous solution of Diglycolamine | 75.4 |
| salt of Dicamba (SL DGA Dicamba) | |
| Preservative (Kathon CG ™, Dow)) | 0.01 |
| Choline chloride (Alfa Aesar) | 2.3 |
| Carbowax PEG 400 E ™, Dow | 9.3 |
| suspending agent | 2.0 |
| (Aerosil R974 ™, Evonik DeGussa) | |
| Non-derivatized guar (Solvay) | 5.0 |
| deionized water | 6.0 |

TABLE VI-A

| | | EX 5 | |
|---|---|---|---|
| Before storage | Viscosity | 520 | cp |
| | (Brookfield LV, | | |
| | @RT) | | |
| | Dilution (1% in CIPAC | acceptable | |
| | D 30° C.) 2 h | dispersibility | |
| After storage | Aspect | stable, little | |
| 54° C. 2 weeks | | phase separation, | |
| | | easy to re-homogenize | |
| | Viscosity | 550 | cp |
| | (Brookfield LV, | | |
| | 20 rpm, SP62 @RT) | | |

RT = Room Temperature

### Drift Measurements

The aqueous spray compositions of Example 5 and reference (Aqueous solution of Diglycolamine salt of Dicamba) were made by diluting compositions Example 5 and reference (Aqueous solution of Diglycolamine salt of Dicamba) in 342 ppm hardness CIPAC water to provide dilute aqueous mixtures containing the relative amount of the respective compositions Example 5 and reference (Aqueous solution of Diglycolamine salt of Dicamba) as percent by weight of the dilute composition in Table VII below.

The dilute aqueous compositions thus obtained were sprayed through a single flat fan nozzle AI11003-VS at a pressure of 40 psi in a flow-controlled hood (speed 1.6 mph) and the droplet size distribution was measured perpendicular to the plane pf spray pattern and 12 inches below the nozzle tip. A Sympatec Laser HELOS-VARIO/KR multi range (Sympatec GmbH, Germany) was used to measure the spray droplets using a R7 lens.

Two parameters V<150 (% of volume of spray droplets of less than 150 microns (i.e., representative of driftable fines)) and VMD (Volume Median Diameter (defined as the droplet size below which 50% volume of spray is contained)) are reported in the Table VII.

The spray compositions of Example 5 exhibited a smaller amount of small size spray droplets that are very susceptible to spray drift, i.e. below 150 μm in size, compared to respective analogous compositions of reference (Aqueous solution of Diglycolamine salt of Dicamba)

TABLE VII

| | ppm non- | | |
|---|---|---|---|
| | derivatized | V < | |
| | guar in dilute | 150 μm | VMD |
| | composition | (%) | (μm) |
| 1.5% wt. Example 5 | 750 | 4.7 | 630.2 |
| 1.2% wt. reference | 0 | 11.6 | 422.9 |
| (Aqueous solution of | | | |
| Diglycolamine salt of Dicamba) | | | |

### Example 6

The composition of Example 6 was an aqueous herbicide composition that contained a pesticide (DMA salt of 2,4D), a water soluble polysaccharide polymer (non-derivatized guar) and a suspending agent (hydrophobic fumed silica).

The composition was prepared as follows. During all the preparation, the medium was stirred using an inox deflocculating blade (diameter 35 mm) at a speed of 300 rpm. 79.3% wt. DMA salt of 2,4D were introduced in a plastic beaker. 0.01% wt. preservative (Kathon CG™, Dow) were added, followed by 2.3% wt. Choline Chloride salt (Alfa Aesar), 2.1% wt. Soprophor TSP/461™ and 9.3% wt. of polyethylene glycol (Carbowax PEG 400 E™, Dow).

Then 2.0% wt. suspending agent (Aerosil R974™, Evonik DeGussa) were slowly added. The formulation was left for 3 hours under stirring (700 rpm). Then 5% wt. non-derivatized guar gum (having a weight average molecular weight of about 2,000,000 g/mol) were slowly introduced (gentle sprinkling using a spatula). The formulation was then left for 1 hour under stirring (300 rpm).

The stability of the composition was evaluated by allowing a sample of the composition to sit undisturbed in a 100 milliLiter (mL) glass vial under hot conditions (54° C., oven) and visually observing the composition to detect viscosity increase and/or separation of the components of the composition due to gravity. Separation of the components of the composition and significant viscosity increase were taken as evidence of instability. Compositions that did not exhibit separation within a given period of time were characterized as being stable for that period of time. Compositions that are easily pourable were characterized as being stable for that period of time.

Example 6 was stable and showed no evidence of viscosity increase nor precipitation or phase separation for 2 weeks at 54° C.

The viscosity of the Example 6 was measured at room temperature using a Brookfield LV viscometer equipped with a SP62 spindle or SSA Low volume, SC4-21 spindle at 20 revolutions per minute (“rpm”).

Samples of the composition of Example 6 was diluted with water CIPAC D (342 ppm) at 30° C.

The materials and their relative amounts used to make the composition of Example 6 are set forth in Table VIII below and the stability and dilution results for Example 6 a are set forth in Table VIII-A below.

TABLE VIII
Concentrated aqueous 2,4D herbicide compositions

| | EX 6 |
|---|---|
| Materials | % wt. |
| Aqueous solution of DMA salt of 2,4D | 79.39 |
| Preservative (Kathon CG ™, Dow)) | 0.01 |
| Choline chloride (Alfa Aesar) | 2.3 |
| Carbowax PEG 400 E ™, Dow | 9.3 |
| suspending agent | 2.0 |
| (Aerosil R974 ™, Evonik DeGussa) | |
| SoprophorTSP/461 ™ | 2.1 |
| Non-derivatized guar (Solvay) | 5.0 |

TABLE VIII-A

| | | EX 6 | |
|---|---|---|---|
| Before storage | Viscosity | 750 | cp |
| | (Brookfield LV, | | |
| | @RT) | | |
| | Dilution (1% in CIPAC | acceptable | |
| | D 30° C.) 2 h | dispersibility | |
| After storage | Aspect | Stable | |
| 54° C. 2 weeks | Viscosity | 510 | cP |
| | (Brookfield LV, | | |
| | 20 rpm, SP62 @RT) | | |

RT = Room Temperature

### Drift Measurements

The aqueous spray compositions of Example 6 and reference (Aqueous solution of DMA salt of 2,4D) were made by diluting compositions Example 6 and reference (Aqueous solution of DMA salt of 2,4D) in 342 ppm hardness CIPAC water to provide dilute aqueous mixtures containing the relative amount of the respective compositions Example 6 and reference (Aqueous solution of DMA salt of 2,4D) as percent by weight of the dilute composition in Table IX below.

The dilute aqueous compositions thus obtained were sprayed through a single flat fan nozzle AI11003-VS at a pressure of 40 psi in a flow-controlled hood (speed 1.6 mph) and the droplet size distribution was measured perpendicular to the plane pf spray pattern and 12 inches below the nozzle tip. A Sympatec Laser HELOS-VARIO/KR multi range (Sympatec GmbH, Germany) was used to measure the spray droplets using a R7 lens.

Two parameters V<150 (% of volume of spray droplets of less than 150 microns (i.e., representative of driftable fines)) and VMD (Volume Median Diameter (defined as the droplet size below which 50% volume of spray is contained)) are reported in the Table IX.

The spray compositions of Example 6 exhibited a smaller amount of small size spray droplets that are very susceptible to spray drift, i.e. below 150 μm in size, compared to respective analogous compositions of reference (Aqueous solution of DMA salt of 2,4D).

TABLE IX

| | ppm non- | | |
|---|---|---|---|
| | derivatized | V < | |
| | guar in dilute | 150 μm | VMD |
| | composition | (%) | (μm) |
| 1.23% wt. Example 6 | 615 | 5.8 | 558.4 |
| 1.00% wt. reference | 0 | 7.3 | 472.2 |
| (Aqueous solution of | | | |
| DMA salt of 2,4D). | | | |

1. A pesticide composition comprising, by total weight of the composition:
a pesticide comprising at least one water-soluble salt of an auxin herbicide;
greater than about 0.5 wt % of a drift control agent suspended in an aqueous liquid medium; and
a suspending agent in an amount effective to impart shear thinning properties to the composition, the suspending agent comprising at least one hydrophobic silica.

2. The composition of claim 1, wherein the suspending agent comprises at least hydrophobic fumed silica.

3. The composition of claim 1, wherein the suspending agent comprises at least a hydrophobic fumed silica which has been hydrophobized by means of dimethyldichlorosilane.

4. The composition of claim 1, wherein the composition comprises greater than about 0.5 wt % of hydrophobic silica, relative to the total weight of the composition.

5. The composition of claim 1, wherein the composition comprises greater than about 5 wt % of an aqueous liquid medium, relative to the total weight of the composition.

6. The composition of claim 1 further comprising the presence of at least 300 g/L of water soluble salts.

7. The composition of claim 1, wherein the composition comprises at least 300 g/L a.e. of the at least one water-soluble salt of the auxin herbicide.

8. The composition of claim 1 wherein the pesticide comprises a dicamba salt, wherein the salt is N,N-bis(3-aminopropyl)methylamine, diethanolamine, monoethanolamine, dimethylamine, isopropylamine, dimethylethanolamine, diglycolamine, potassium, choline, or sodium.

9. The composition of claim 1 wherein the pesticide comprises dicamba diglycolamine salt or dicamba N,N-bis(3-aminopropyl)methylamine salt.

10. The composition of claim 1 wherein the drift control agent is a water-soluble polymer.

11. The composition of claim 1 wherein the drift control agent comprises a guar derivative, the guar derivative comprising cationic guar, carboxymethyl guar (CM guar), hydroxyethyl guar (HE guar), hydroxypropyl guar (HP guar), carboxymethylhydroxypropyl guar (CMHP guar), hydrophobically modified guar (HM guar), hydrophobically modified carboxymethyl guar (HMCM guar), hydrophobically modified hydroxyethyl guar (HMHE guar), hydrophobically modified hydroxypropyl guar (HMHP guar), cationic hydrophobically modified hydroxypropyl guar (cationic HMHP guar), hydrophobically modified carboxymethylhydroxypropyl guar (HMCMHP guar), hydrophobically modified cationic guar (HM cationic guar), guar hydroxypropyl trimonium chloride, or hydroxypropyl guar hydroxypropyl trimonium chloride.

12. The composition of claim 1 wherein the drift control agent is native guar, polyacrylamide, a cationic hydroxypropyl guar, a cationic guar, or a combination thereof.

13. The composition of claim 1, wherein the drift control agent is a fatty deposition control agent.

14. The composition of claim 1, wherein the composition further comprises a hydration inhibitor component.

15. The composition of claim 13, wherein said hydration inhibitor component comprises propylene glycol or poly(ethylene glycol).

16. The composition of claim 13, wherein the hydration inhibitor component further comprises choline chloride.

17. The composition of claim 1 further comprising one or more surfactants.

18. The composition of claim 1 wherein the composition exhibits a viscosity of less than 10 Pa·s at a shear rate of greater than or equal to 10 s⁻¹.

19. The composition of claim 1 wherein the composition comprises greater than about 1 wt % of the drift control agent suspended in the aqueous liquid medium.

20. The composition of claim 1 wherein the composition exhibits:
(a) a viscosity of greater than or equal to 5 Pa·s at a shear rate of less than 0.01 s⁻¹, and
(b) a viscosity of less than 5 Pa·s at a shear rate of greater than 10 s⁻¹.

21. The composition of claim 1 wherein the composition is free or substantially free of ammonium-containing water conditioning agent.
